(19) United States
(12) Patent Application Publication
(10) Pub. No.: US 2026/0023938 A1
(43) Pub. Date: Jan. 22, 2026

(54) TEXT PROCESSING

(71) Applicant: TENCENT TECHNOLOGY (SHENZHEN) COMPANY LIMITED, Shenzhen (CN)

(72) Inventors: Zhongzhi CHEN, Shenzhen (CN); Xingwu SUN, Shenzhen (CN); Xianfeng JIAO, Shenzhen (CN); Fengzong LIAN, Shenzhen (CN); Zhanhui KANG, Shenzhen (CN); Di WANG, Shenzhen (CN); Chengzhong XU, Shenzhen (CN); Ruobing XIE, Shenzhen (CN)

(73) Assignee: TENCENT TECHNOLOGY (SHENZHEN) COMPANY LIMITED, Shenzhen (CN)

(21) Appl. No.: 19/340,576

(22) Filed: Sep. 25, 2025

Related U.S. Application Data
(63) Continuation of application No. PCT/CN2024/109812, filed on Aug. 5, 2024.

(30) Foreign Application Priority Data
Sep. 28, 2023 (CN) 202311294826.9

(51) Int. Cl. G06F 40/51

(52) U.S. Cl. CPC G06F 40/51

(57) ABSTRACT

In a method, an initial text feature of a to-be-processed text is obtained based on feature encoding of the to-be-processed text. One or more truthfulness prediction results of the to-be-processed text in one or more prediction dimensions are obtained, the one or more truthfulness prediction results corresponding to one or more truthfulness predictions of logic of the to-be-processed text in the one or more prediction dimensions based on the initial text feature. For each prediction dimension, a correction feature of the initial text feature is obtained when the corresponding truthfulness prediction result in the respective prediction dimension indicates that the to-be-processed text is not truthful in the respective prediction dimension. A target text feature corresponding to the initial text feature is obtained based on the correction feature for each prediction dimension. A target text corresponding to the to-be-processed text is obtained based on feature decoding of the target text feature.

### RELATED APPLICATIONS

The present application is a continuation of International Application No. PCT/CN2024/109812, filed on Aug. 5, 2024, which claims priority to Chinese Patent Application No. 202311294826.9, filed on Sep. 28, 2023. The entire disclosures of the prior applications are hereby incorporated by reference.

### FIELD OF THE TECHNOLOGY

This disclosure relates to the field of computer technologies, including a text processing method and apparatus, an electronic device, a computer-readable storage medium, and a computer program product.

### BACKGROUND OF THE DISCLOSURE

Artificial intelligence (AI) involves a theory, a method, a technology, and an application system that uses a digital computer or a machine controlled by the digital computer to simulate, extend, and expand human intelligence, perceive an environment, obtain knowledge, and use the knowledge to obtain an optimal result. Basic technologies of the artificial intelligence may include a sensor, a dedicated artificial intelligence chip, cloud computing, distributed storage, a big data processing technology, a pre-trained model technology, an operating/interaction system, electromechanical integration, and the like. The pre-trained model is also referred to as a large model or a basic model, and may be widely used in downstream tasks in various directions of the artificial intelligence after fine-tuning. Artificial intelligence software technologies mainly include several major directions such as a computer vision technology, a speech processing technology, a natural language processing technology, and machine learning/deep learning.

In some applications, for text processing, feature encoding and feature decoding are usually directly performed on a to-be-processed text, to obtain a target text of the to-be-processed text. In this way, because a hallucination phenomenon exists in a text processing process, the truthfulness of the target text may be degraded in a prediction dimension. Consequently, accuracy of the determined target text is low, and accuracy of text processing is low.

### SUMMARY

Embodiments of this disclosure provide a text processing method and apparatus, an electronic device, a computer-readable storage medium, and a computer program product, to more effectively improve accuracy of text processing.

Examples of technical solutions of this disclosure are as follows:

An aspect of the embodiments of this disclosure provides a text processing method. In the text processing method, an initial text feature of a to-be-processed text is obtained based on feature encoding of the to-be-processed text. One or more truthfulness prediction results of the to-be-processed text in one or more prediction dimensions are obtained, the one or more truthfulness prediction results corresponding to one or more truthfulness predictions of logic of the to-be-processed text in the one or more prediction dimensions based on the initial text feature. For each of the one or more prediction dimensions, a correction feature of the initial text feature in the respective prediction dimension is obtained when the corresponding truthfulness prediction result in the respective prediction dimension indicates that the to-be-processed text is not truthful in the respective prediction dimension. A target text feature corresponding to the initial text feature is obtained based on the correction feature for each of the one or more prediction dimensions. A target text corresponding to the to-be-processed text is obtained by processing circuitry based on feature decoding of the target text feature.

An aspect of the embodiments of this disclosure provides a text processing apparatus. The text processing apparatus includes processing circuitry configured to obtain an initial text feature of a to-be-processed text based on feature encoding of the to-be-processed text. The processing circuitry is configured to obtain one or more truthfulness prediction results of the to-be-processed text in one or more prediction dimensions, the one or more truthfulness prediction results corresponding to one or more truthfulness predictions of logic of the to-be-processed text in the one or more prediction dimensions based on the initial text feature. The processing circuitry is configured to, for each of the one or more prediction dimensions, obtain a correction feature of the initial text feature in the respective prediction dimension when the corresponding truthfulness prediction result in the respective prediction dimension indicates that the to-be-processed text is not truthful in the respective prediction dimension. The processing circuitry is configured to obtain a target text feature corresponding to the initial text feature based on the correction feature for each of the one or more prediction dimensions. The processing circuitry is configured to obtain a target text corresponding to the to-be-processed text based on feature decoding of the target text feature.

An aspect of the embodiments of this disclosure provides a non-transitory computer-readable storage medium. The non-transitory computer-readable storage medium stores instructions, which when executed by a processor, cause the processor to perform obtaining an initial text feature of a to-be-processed text based on feature encoding of the to-be-processed text. The instructions, which when executed by the processor, cause the processor to perform obtaining one or more truthfulness prediction results of the to-be-processed text in one or more prediction dimensions, the one or more truthfulness prediction results corresponding to one or more truthfulness predictions of logic of the to-be-processed text in the one or more prediction dimensions based on the initial text feature. The instructions, which when executed by the processor, cause the processor to perform, for each of the one or more prediction dimensions, obtaining a correction feature of the initial text feature in the respective prediction dimension when the corresponding truthfulness prediction result in the respective prediction dimension indicates that the to-be-processed text is not truthful in the respective prediction dimension. The instructions, which when executed by the processor, cause the processor to perform obtaining a target text feature corresponding to the initial text feature based on the correction feature for each of the one or more prediction dimensions. The instructions, which when executed by the processor, cause the processor to perform obtaining a target text corresponding to the to-be-processed text based on feature decoding of the target text feature.

An aspect of the embodiments of this disclosure provides a text processing method, including: performing feature encoding on a to-be-processed text, to obtain an initial text feature of the to-be-processed text; performing truthfulness prediction on logic of the to-be-processed text in at least one prediction dimension based on the initial text feature, to obtain a truthfulness prediction result of the to-be-processed text in each prediction dimension; when the truthfulness prediction result indicates that the to-be-processed text is not truthful in the corresponding prediction dimension, obtaining a correction feature of the initial text feature in the corresponding prediction dimension; performing feature correction on the initial text feature based on the correction feature, to obtain a target text feature corresponding to the initial text feature; and performing feature decoding on the target text feature, to obtain a target text corresponding to the to-be-processed text, the target text being truthful in each prediction dimension.

An aspect of the embodiments of this disclosure provides a text processing apparatus, including: a feature encoding module, configured to perform feature encoding on a to-be-processed text, to obtain an initial text feature of the to-be-processed text; a truthfulness prediction module, configured to perform truthfulness prediction on logic of the to-be-processed text in at least one prediction dimension based on the initial text feature, to obtain a truthfulness prediction result of the to-be-processed text in each prediction dimension; an obtaining module, configured to: when the truthfulness prediction result indicates that the to-be-processed text is not truthful in the corresponding prediction dimension, obtain a correction feature of the initial text feature in the corresponding prediction dimension; a feature correction module, configured to perform feature correction on the initial text feature based on the correction feature, to obtain a target text feature corresponding to the initial text feature; and a feature decoding module, configured to perform feature decoding on the target text feature, to obtain a target text corresponding to the to-be-processed text, the target text being truthful in each prediction dimension.

An aspect of the embodiments of this disclosure provides an electronic device, including: a memory, configured to store computer-executable instructions or a computer program; and a processor, configured to implement, when executing the computer-executable instructions or computer program stored in the memory, the text processing method provided in one or more embodiments of this disclosure.

An aspect of the embodiments of this disclosure provides a non-transitory computer-readable storage medium storing computer-executable instructions, which when executed by a processor, causing the processor to perform the information processing method according to one or more embodiments of this disclosure.

An embodiment of this disclosure provides a computer program product, the computer program product including a computer program or computer-executable instructions, and the computer program or the computer-executable instructions being stored in a non-transitory computer-readable storage medium. A processor of an electronic device reads the computer-executable instructions from the non-transitory computer-readable storage medium, and the processor executes the computer-executable instructions, so that the electronic device executes the foregoing text processing method in one or more embodiments of this disclosure.

Some embodiments of this disclosure have one or more of the following beneficial effects.

Feature encoding is performed on the to-be-processed text, to obtain the initial text feature of the to-be-processed text. Truthfulness prediction is performed on the logic of the to-be-processed text in the at least one prediction dimension based on the initial text feature, to obtain the truthfulness prediction result of the to-be-processed text in each prediction dimension. When the truthfulness prediction result indicates that the to-be-processed text is not truthful in a corresponding prediction dimension, a correction feature in the corresponding prediction dimension is obtained. Feature correction is performed on the initial text feature based on the correction feature, to obtain the target text feature corresponding to the initial text feature. Feature decoding is performed on the target text feature, to obtain the target text being truthful in each prediction dimension. In this way, truthfulness prediction is performed on the logic of the to-be-processed text in at least one prediction dimension based on the initial text feature, to obtain the truthfulness prediction result of the to-be-processed text in each prediction dimension. Feature correction is performed on the initial text feature, to obtain the target text feature, and feature decoding is performed on the target text feature, so that the target text is truthful in each prediction dimension, thereby effectively improving accuracy of the target text, and effectively improving accuracy of text processing.

### BRIEF DESCRIPTION OF THE DRAWINGS

FIG. 1 is a schematic diagram of an architecture of a text processing system according to an embodiment of this disclosure.

FIG. 2 is a schematic diagram of a structure of an electronic device for text processing according to an embodiment of this disclosure.

FIG. 3 is a schematic flowchart of a text processing method according to an embodiment of this disclosure.

FIG. 4 is a schematic flowchart of a text processing method according to an embodiment of this disclosure.

FIG. 5 is a schematic diagram of a principle of a text processing method according to an embodiment of this disclosure.

FIG. 6 is a schematic flowchart of a text processing method according to an embodiment of this disclosure.

FIG. 7 is a schematic flowchart of a text processing method according to an embodiment of this disclosure.

FIG. 8 is a schematic flowchart of a text processing method according to an embodiment of this disclosure.

FIG. 9 is a schematic diagram of a principle of a text processing method according to an embodiment of this disclosure.

FIG. 10 is a schematic diagram of experimental results of a text processing method according to an embodiment of this disclosure.

### DESCRIPTION OF EMBODIMENTS

To make objectives, technical solutions, and advantages of this disclosure clearer, the following describes this disclosure in further detail with reference to the accompanying drawings. The described embodiments are not to be considered as a limitation to this disclosure. Other embodiments are within the scope of the disclosure.

In the following descriptions, the term “some embodiments” describes a subset of all possible embodiments. However, the term “some embodiments” may be the same subset or different subsets of all possible embodiments, and may be combined with each other without conflict.

In the following descriptions, the term “first/second/third” is merely used for distinguishing similar objects and does not represent a specific order of objects. The term “first/second/third” may be interchanged with a specific order or priority if permitted, so that embodiments of this disclosure described herein can be implemented in an order other than that illustrated or described herein.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

Unless otherwise defined, meanings of all technical and scientific terms used in this specification are the same as those understood by a person skilled in the art to which this disclosure belongs. The terms used in the specification are merely intended to describe the objectives of embodiments of this disclosure, and are not intended to limit this disclosure.

Before embodiments of this disclosure are further described in detail, examples of technical terms in embodiments of this disclosure are provided.

(1) AI may involve a theory, a method, a technology, and an application system that use a digital computer or a machine controlled by the digital computer to simulate, extend, and expand human intelligence, perceive an environment, obtain knowledge, and use knowledge to obtain an optimal result. The artificial intelligence technology is a comprehensive subject, relating to a wide range of fields, and involving both hardware and software techniques. Basic artificial intelligence technologies may include technologies such as a sensor, a dedicated artificial intelligence chip, cloud computing, distributed storage, a big data processing technology, an operating/interaction system, and electromechanical integration.

(2) A convolutional neural network (CNN) may correspond to a type of feedforward neural network (FNN) including convolutional computation and having a deep structure, and may be one of the representative algorithms of deep learning. The convolutional neural network has a representation learning capability, and can perform shift-invariant classification on an input image according to a hierarchical structure thereof.

(3) Machine learning (ML) may correspond to a multi-field interdiscipline, and may relate to a plurality of disciplines such as the probability theory, statistics, the approximation theory, convex analysis, and the algorithm complexity theory. It may specialize in the study of how computers simulate or implement human learning behaviors to obtain new knowledge or skills and reorganize existing knowledge structures, to continuously improve their performance.

(4) The “in response to” is configured for representing a condition or status on which one or more to-be-performed operations depend. When the condition or status is met, the one or more operations may be performed in real time or have a set delay. Unless otherwise specified, there is no chronological order between the plurality of to-be-performed operations.

(5) A large language model (LLM) is a deep learning model trained by using a large amount of text data, and may generate a natural language text or understand a meaning of a language text. The large language model can process a plurality of natural language tasks, such as text classification, question answering, and dialog, and is an important approach to artificial intelligence. In some examples, the large language model is intended to understand and generate human languages. They are trained on a large amount of text data, and can perform a wide range of tasks, including text summarization, translation, sentiment analysis, and the like. Large language models are characterized by a large scale and include billions of parameters, helping them learn complex patterns in language data. These models are usually based on a deep learning architecture such as a converter, which helps them achieve impressive representation on various natural language processing tasks. In some examples, a pre-trained model corresponds to a technology of model training developed from a large language model in the field of NLP. After fine tuning, the large language model may be widely applied to downstream tasks.

(6) The natural language processing (NLP) corresponds to various theories and methods that can realize efficient communication between humans and computers by using a natural language. Natural language processing is a science that integrates linguistics, computer science, and mathematics. Therefore, the study in this field will involve the natural language, that is, the language used by people in daily life, so it is closely related to the study of linguistics, but there are important differences. The natural language processing may not correspond to research of the natural language, but corresponds to develop of a computer system that can effectively implement natural language communication, especially, a software system. Therefore, natural language processing is a part of computer science, and natural language processing may be applied to aspects such as machine translation, public opinion detection, automatic abstract, opinion extraction, text classification, question and answering, text semantic comparison, and speech recognition.

In an implementation process of embodiments of this disclosure, the applicant finds that the related art has the following problems.

In a related technology, for text processing, feature encoding and feature decoding are usually directly performed on a to-be-processed text, to obtain a target text of the to-be-processed text. In this way, because a hallucination phenomenon exists in a text processing process, the truthfulness of the target text may be degraded in a prediction dimension. Consequently, accuracy of the determined target text is low, and accuracy of text processing is low.

Embodiments of this disclosure provide a text processing method and apparatus, an electronic device, a non-transitory computer-readable storage medium, and a computer program product, to more effectively improve accuracy of text processing. The following describes non-limiting examples of a text processing system provided in embodiments of this disclosure.

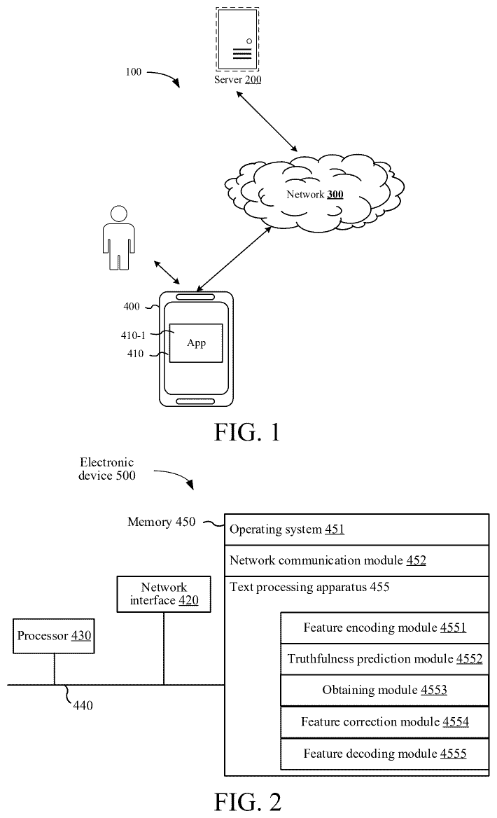

FIG. 1 is a schematic diagram of an architecture of a text processing system 100 according to an embodiment of this disclosure. A terminal (for example, a terminal 400 is shown) is connected to a server 200 through a network 300. The network 300 may be a wide area network, a local area network, or a combination thereof.

The terminal 400 is configured for a user to use a client 410, and displays a target text in a graphical interface 410-1 (for example, the graphical interface 410-1 is shown). The terminal 400 and the server 200 are connected to each other through a wired or wireless network.

In some embodiments, the server 200 may be an independent physical server, a server cluster or distributed system including a plurality of physical servers, or a cloud server providing a basic cloud computing service such as a cloud service, a cloud database, cloud computing, a cloud function, cloud storage, a network service, cloud communication, a middleware service, a domain name service, a security service, a content delivery network (CDN), and a big data and artificial intelligence platform. The terminal 400 may be a smartphone, a tablet computer, a notebook computer, a desktop computer, a smart speaker, a smart television, a smartwatch, an in-vehicle terminal, or the like, but is not limited thereto. The electronic device provided in embodiments of this disclosure may be implemented as a terminal, or may be implemented as a server. The terminal and the server may be directly or indirectly connected through wired or wireless communication. This is not limited in embodiments of this disclosure.

In some embodiments, the server 200 performs feature encoding on a to-be-processed text, to obtain an initial text feature of the to-be-processed text, determines a target text feature corresponding to the initial text feature, performs feature decoding on the target text feature, to obtain a target text corresponding to the to-be-processed text, and sends the target text to the terminal 400.

In other embodiments, the terminal 400 performs feature encoding on a to-be-processed text, to obtain an initial text feature of the to-be-processed text, determines a target text feature corresponding to the initial text feature, performs feature decoding on the target text feature, to obtain a target text corresponding to the to-be-processed text, and sends the target text to the server 200.

In other embodiments, embodiments of this disclosure may alternatively be implemented through a cloud technology. The cloud technology refers to a hosting technology that unifies a series of resources such as hardware, software, and networks within a wide area network or a local area network to implement data calculation, storage, processing, and sharing.

The cloud technology is a generic term of a network technology, an information technology, an integration technology, a management platform technology, and an application technology based on application of a cloud computing business model. It may form a resource pool and may be used on demand, which is flexible and convenient. Cloud computing technology is to become an important support. A backend service of a technical network system needs a large quantity of computing and storage resources.

FIG. 2 is a schematic diagram of a structure of an electronic device 500 for text processing according to an embodiment of this disclosure. The electronic device 500 shown in FIG. 2 may be the server 200 or the terminal 400 shown in FIG. 1. The electronic device 500 shown in FIG. 2 includes processing circuitry such as one or more processors 430, a memory 450, and at least one network interface 420. Components in the electronic device 500 are coupled together through a bus system 440. The bus system 440 is configured to implement connection and communication between these components. In addition to a data bus, the bus system 440 further includes a power bus, a control bus, and a state signal bus. However, for ease of clear description, all types of buses are marked as the bus system 440 in FIG. 2.

The processor 430 may be an integrated circuit chip having a signal processing capability, for example, a general purpose processor, a digital signal processor (DSP) or another programmable logic device, a discrete gate or transistor logic device, a discrete hardware component, or the like. The general purpose processor may be a microprocessor, any suitable processor, or the like.

The memory 450 may be removable, irremovable, or a combination thereof. Examples of hardware devices include a solid-state memory, a hard disk drive, an optical disk drive, and the like. In an embodiment, the memory 450 includes one or more storage devices physically located away from the processor 430.

The memory 450 includes a volatile memory or a non-volatile memory, or may include both a volatile memory and a non-volatile memory. The non-volatile memory may be a read only memory (ROM). The volatile memory may be a random access memory (RAM). The memory 450 described in embodiments of this disclosure aims to include any other suitable type of memory.

In some embodiments, the memory 450 can store data to support various operations. Examples of the data include a program, a module, and a data structure, or a subset or a superset thereof, which are described below as non-limiting examples.

An operating system 451 includes system programs configured to process various basic system services and perform hardware-related tasks, for example, a framework layer, a core library layer, and a driver layer, which are configured to implement various basic services and process hardware-based tasks.

A network communication module 452 is configured to reach another electronic device through one or more (wired or wireless) network interfaces 420. In one or more examples, a network interface 420 includes Bluetooth, Wi-Fi, a universal serial bus (USB), and the like.

In some embodiments, the text processing apparatus provided in embodiments of this disclosure may be implemented by using software. FIG. 2 shows a text processing apparatus 455 stored in the memory 450. The text processing apparatus 455 may be software in a form of a program, a plug-in, and the like, including the following software modules: a feature encoding module 4551, a truthfulness prediction module 4552, an obtaining module 4553, a feature correction module 4554, and a feature decoding module 4555. These modules are logical and may be arbitrarily combined or further split depending on implemented functions. Functions of the modules are described below.

In other embodiments, the text processing apparatus provided in embodiments of this disclosure may be implemented by using hardware. For example, the text processing apparatus provided in embodiments of this disclosure may be a processor in a form of a hardware decoding processor, programmed to perform the text processing method provided in embodiments of this disclosure. For example, the processor in the form of a hardware decoding processor may use one or more application specific integrated circuits (ASICs), a DSP, a programmable logic device (PLD), a complex programmable logic device (CPLD), a field-programmable gate array (FPGA), or another electronic element.

In some embodiments, the terminal or the server may implement the text processing method provided in embodiments of this disclosure by running a computer program or computer-executable instructions. For example, the computer program may be a native program (for example, a dedicated text processing program) or a software module in an operating system, for example, a text processing module that may be embedded in any program (for example, an instant messaging client, an album program, an electronic map client, or a navigation client), or may be a native application (APP), that is, a program that needs to be installed in the operating system for running. In conclusion, the foregoing computer program may be an application, a module, or a plug-in in any form.

The text processing method provided in embodiments of this disclosure is described with reference to non-limiting examples of applications and implementations of the server or the terminal provided in embodiments of this disclosure.

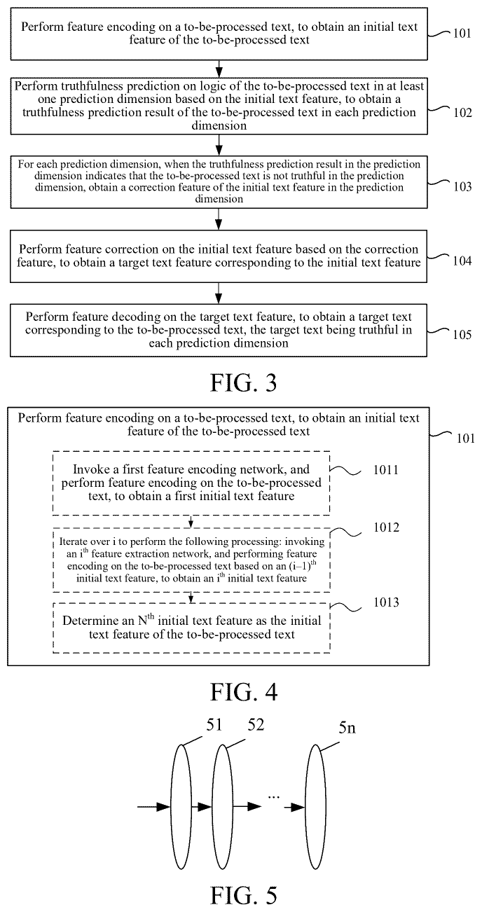

FIG. 3 is a schematic flowchart of a text processing method according to an embodiment of this disclosure. Descriptions are provided with reference to operation 101 to operation 105 shown in FIG. 3. The text processing method provided in this embodiment of this disclosure may be independently implemented by a server or a terminal, or may be cooperatively implemented by a server and a terminal. The following describes an example in which the server independently implements the method.

Operation 101: Perform feature encoding on a to-be-processed text, to obtain an initial text feature of the to-be-processed text. In one example, an initial text feature of a to-be-processed text is obtained based on feature encoding of the to-be-processed text.

In some embodiments, the feature encoding is a processing process of converting the to-be-processed text in a text form into the initial text feature in a vector form. In machine learning, pattern recognition, and image processing, the feature encoding starts from an initial set of measurement data, and builds derived values (features) intended to be informative and non-redundant, to facilitate subsequent learning and generalization operations and bring better interpretability in some cases. The feature encoding is related to dimensionality reduction. Quality of a feature has a vital impact on a generalization ability.

In some embodiments, in natural language processing (NLP) and machine learning, the feature encoding is a process of converting text data into a numeric feature that can be understood and processed by a machine learning model. In the natural language processing, the text data is unstructured, and includes abundant information and a complex semantic structure. However, most machine learning models require structured and quantitative inputs. The feature encoding can enable text data to be effectively used by an algorithm.

In some embodiments, the feature encoding is implemented by using at least one feature encoding network. When there is one feature encoding network, operation 101 may be implemented in the following manner: The feature encoding network is invoked, and feature encoding is performed on the to-be-processed text, to obtain the initial text feature of the to-be-processed text.

In some embodiments, the feature encoding network may be implemented by using an encoding network. The encoding network may be a machine learning network using a multi-headed self-Attention network as a network framework. A specific implementation of the feature encoding network does not constitute a limitation to this embodiment of this disclosure.

In some embodiments, the encoding network is a neural network structure, and is configured for mapping input data (for example, a text) to a more abstract and compact representation form, usually configured for capturing a complex feature and structure of data. In the natural language processing (NLP), the encoding network can convert a text into a vector representation that can represent semantic and syntactic information of the text.

In some embodiments, the feature encoding is implemented by using at least one feature encoding network. FIG. 4 is a schematic flowchart of a text processing method according to an embodiment of this disclosure. When there are a plurality of feature encoding networks, extraction scales of the feature encoding networks are different. Operation 101 shown in FIG. 3 may be implemented by performing operation 1011 to operation 1013 shown in FIG. 4.

Operation 1011: Invoke a first feature encoding network, and perform feature encoding on the to-be-processed text, to obtain a first initial text feature. In one example, the feature encoding is based on at least one feature encoding network. When the at least one feature encoding network corresponds to N feature encoding networks, N being an integer greater than 1, the obtaining the initial text feature of the to-be-processed text includes obtaining a first initial text feature based on a first feature encoding network being applied to the to-be-processed text.

In an example, FIG. 5 is a schematic diagram of a principle of a text processing method according to an embodiment of this disclosure. A first feature encoding network 51 is invoked, and feature encoding is performed on the to-be-processed text, to obtain a first initial text feature.

Operation 1012: Iterate over i to perform the following processing: invoking an i^{th} feature encoding network, and performing feature encoding on the to-be-processed text based on an (i−1)^{th} initial text feature, to obtain an i^{th} initial text feature. In one example, the obtaining the initial text feature of the to-be-processed text includes obtaining an i^{th} initial text feature based on an i^{th} feature encoding network being applied to the to-be-processed text based on an (i−1)^{th} initial text feature.

In some embodiments, 1<i≤N, and N indicates a quantity of feature encoding networks.

In an example, as shown in FIG. 5, a second feature encoding network 52 is invoked, and feature encoding is performed on the to-be-processed text based on the first initial text feature, to obtain a second initial text feature. An n^{th} feature encoding network 5n is invoked, and feature encoding is performed on the to-be-processed text based on an (n−1)^{th} initial text feature, to obtain an n^{th} initial text feature.

In some embodiments, before operation 1012 is performed, an (i−1)^{th} target text feature may be determined in the following manner: Truthfulness prediction is performed on logic of the to-be-processed text in each prediction dimension based on the (i−1)^{th} initial text feature, to obtain an (i−1)^{th} truthfulness prediction result of the to-be-processed text in each prediction dimension. Feature check is performed on the (i−1)^{th} initial text feature based on the (i−1)^{th} truthfulness prediction result, to obtain the (i−1)^{th} target text feature. In one example, the obtaining the i^{th} initial text feature further includes obtaining an (i−1)^{th} truthfulness prediction result of the to-be-processed text corresponding to truthfulness prediction of the logic of the to-be-processed text in each prediction dimension based on the (i−1)^{th} initial text feature. In one example, the obtaining the i^{th} initial text feature further includes obtaining an (i−1)^{th} target text feature based on a feature check of the (i−1)^{th} initial text feature and the (i−1)^{th} truthfulness prediction result. In one example, the obtaining the i^{th} initial text feature includes applying the i^{th} feature encoding network to the to-be-processed text based on the (i−1)^{th} target text feature.

In some embodiments, accuracy of text truthfulness detection is significantly improved through such iterative feature processing and truthfulness prediction. In each iterative operation, truthfulness prediction is performed based on an initial text feature from the previous operation. Inaccuracy or inconsistency in text features can be identified and corrected in a timely manner. Subsequently, the text features are further optimized through feature check, to enhance the performance of obtaining the text features matching the truthfulness prediction results, to obtain more accurate target text features. This dynamic adjustment and optimization process makes a feature representation to focus more on text truthfulness, to improve an ability of a model to identify truthfulness. In addition, through a plurality of iterations, the model can gradually extract deeper and more subtle features. This is crucial for understanding and evaluating text truthfulness, and more accurate prediction performance may be ultimately achieved in all prediction dimensions.

In some embodiments, truthfulness prediction may be performed on the logic of the to-be-processed text in each prediction dimension based on the (i−1)^{th} initial text feature, to obtain the (i−1)^{th} truthfulness prediction result of the to-be-processed text in each prediction dimension in the following manner: A truthfulness prediction network corresponding to each prediction dimension is obtained, and the following processing is performed for each prediction dimension: invoking the corresponding truthfulness prediction network; performing truthfulness prediction on the logic of the to-be-processed text in the prediction dimension based on the (i−1)^{th} initial text feature, to obtain an (i−1)^{th} truthfulness score of the to-be-processed text in the prediction dimension; when the (i−1)^{th} truthfulness score is greater than or equal to a score threshold, determining the (i−1)^{th} truthfulness prediction result in the prediction dimension as a first result; and when the (i−1)^{th} truthfulness score is less than the score threshold, determining the (i−1)^{th} truthfulness prediction result in the prediction dimension as a second result.

In some embodiments, the first result indicates that the to-be-processed text is truthful in the prediction dimension, and the second result indicates that the to-be-processed text is not truthful in the prediction dimension.

In an example, in an application scenario of online news truthfulness detection, the prediction dimension may be: a content truthfulness dimension, configured for evaluating whether news content is based on facts; a source reliability dimension, configured for evaluating credibility and reliability of a news source; and a logical consistency dimension, configured for evaluating whether logic in the news content is coherent. For content truthfulness, a deep learning-based classification network is specifically trained to identify whether the news content is truthful. For source reliability, there is a model for evaluating history and credibility of a news source. For logical consistency, there is a network for detecting internal text contradictions and logical errors. The to-be-processed text is a piece of newly released online news. The (i−1)^{th} initial text feature is represented by a text feature obtained in a previous iteration. The score threshold is, for example, 0.5, and is configured for determining a truthfulness score. A classification network for content truthfulness is obtained from a model base. An evaluation model for source reliability is obtained from a model base. A detection network for logical consistency is obtained from a model base. The classification network for content truthfulness is invoked, and the (i−1)^{th} initial text feature is input, to obtain a truthfulness score, for example, 0.6. Determine: 0.6>=0.5. Therefore, a prediction result of content truthfulness is determined as the first result (truthful). The evaluation model for source reliability is invoked, and the (i−1)^{th} initial text feature is input, to obtain a truthfulness score, for example, 0.4. Determine: 0.4<0.5. Therefore, a prediction result of source reliability is determined as the second result (untruthful). The detection network for logical consistency is invoked, and the (i−1)^{th} initial text feature is input, to obtain a truthfulness score, for example, 0.7. Determine: 0.7>=0.5. Therefore, a prediction result of logical consistency is determined as the first result (truthful). For the content truthfulness dimension, the prediction result is the first result (truthful). For the source reliability dimension, the prediction result is the second result (untruthful). For the logical consistency dimension, the prediction result is the first result (truthful). In this manner, evaluation is performed in each prediction dimension by using a dedicated network, and a truthfulness prediction result is determined based on the score threshold, to comprehensively evaluate truthfulness of a text, thereby improving accuracy of an entire truthfulness detection system.

In this way, customized evaluation can be provided for each prediction dimension, to significantly improve overall accuracy and reliability of text truthfulness detection. The dedicated network is allocated to each prediction dimension, so that information specific to the dimension can be better captured and processed, so that truthfulness prediction is more accurate. Performing truthfulness scoring based on the (i−1)^{th} initial text feature not only fully uses valuable information extracted in a previous iteration, but also provides a clear decision criterion for each dimension through application of the score threshold. This not only makes a prediction result more interpretable, but also provides finer guidance for subsequent decision or processing through distinguishing between the first result and the second result.

In some embodiments, when there is one prediction dimension, the truthfulness prediction network corresponding to each prediction dimension may be obtained in the following manner: An initial prediction network is obtained, and a plurality of text feature samples corresponding to a text sample and truthfulness label scores of the text feature samples are obtained. For each text feature sample, the initial prediction network is invoked, truthfulness prediction is performed on logic of the text sample of the prediction dimension based on the text feature sample, to obtain a truthfulness score corresponding to the text feature sample, and a loss value corresponding to the text feature sample is determined with reference to the truthfulness score and the corresponding truthfulness label score. The initial prediction network is trained based on the loss value corresponding to each text feature sample, to obtain the truthfulness prediction network corresponding to the prediction dimension.

In some embodiments, the plurality of text feature samples corresponding to the text sample may be obtained in the following manner: The text sample is obtained, and feature encoding is performed on the text sample, to obtain an initial text feature of the text sample. Feature splitting is performed on the initial text feature of the text sample, to obtain the plurality of text feature samples corresponding to the text sample.

In an example, in an application scenario of comment truthfulness detection on a social media platform, the initial prediction network may be a deep learning-based classification model, configured for text truthfulness prediction. The text feature sample may be a feature vector obtained by performing preprocessing and feature extraction on a comment collected on the social media platform. The truthfulness label score may be a truthfulness label of each comment, is usually manually marked, and indicates whether the comment is truthful or untruthful. Text sample 1: comment content “This product is really very good, and I like it very much!”. Text feature sample 1: a feature vector obtained through feature extraction, such as a bag-of-words model or word embedding. Truthfulness label score 1:0.9 (indicating that the comment is probably truthful). A large quantity of social media comments and corresponding truthfulness label scores are collected. The comments are preprocessed, to extract text features, to obtain a text feature sample set and a corresponding truthfulness label score set. For each text feature sample, the initial prediction network is invoked to perform truthfulness prediction. It is assumed that for the text feature sample 1, a truthfulness score provided by the initial prediction network is 0.85. A loss function (such as a cross entropy loss or a mean square error) is configured for calculating a difference between the predicted value and the truthfulness label value. For the text feature sample 1, a loss value may be calculated as (0.9-0.85)\hat{ }2. The initial prediction network is trained by using loss values of all text feature samples. A network parameter is adjusted by using optimization algorithms such as back propagation and gradient descent, to reduce the loss value. After sufficient training iterations, the initial prediction network may gradually learn and improve a prediction capability of the initial prediction network. Finally, a trained network is a truthfulness prediction network for a particular prediction dimension.

In some embodiments, the loss value corresponding to the text feature sample may be determined with reference to the truthfulness score and the corresponding truthfulness label score in the following manner: A difference between the truthfulness score and the corresponding truthfulness label score is determined, and the difference is determined as the loss value corresponding to the text feature sample.

In this way, the initial prediction network is configured for truthfulness evaluation on the to-be-processed text feature sample. By continuously performing iterative prediction and calculating the loss value, the network can gradually learn and capture a complex relationship between text features and truthfulness. This training method enables the prediction network to be specially optimized for different prediction dimensions, thereby significantly improving performance of the prediction network on a truthfulness detection task. Finally, a fully trained prediction network can predict truthfulness of a text more accurately, and provide a powerful tool for scenarios such as a social media platform and a news aggregator to identify and filter untruthful information, thereby enhancing credibility of information propagation and user security.

In some embodiments, when there are a plurality of prediction dimensions, a truthfulness prediction network corresponding to each prediction dimension may be obtained in the following manner: An initial prediction network is obtained, and a first text feature sample corresponding to a text sample of a first prediction dimension, and a first truthfulness label score of the first text feature sample are obtained. The initial prediction network is invoked, truthfulness prediction is performed on logic of the text sample of the first prediction dimension based on the first text feature sample, to obtain a first truthfulness score, and the initial prediction network is trained with reference to the first truthfulness score and the first truthfulness label score, to obtain a truthfulness prediction network corresponding to the first prediction dimension. j is iterated over, to perform the following processing: obtaining a (j−1)^{th} truthfulness score corresponding to a text sample of a (j−1)^{th} prediction dimension, and the initial prediction network is trained based on the (j−1)^{th} truthfulness score, to obtain a truthfulness prediction network corresponding to a j^{th} prediction dimension.

In one example, when the one or more prediction dimensions correspond to M prediction dimensions, M being a positive integer greater than 1, the obtaining the truthfulness prediction network corresponding to each prediction dimension includes obtaining an initial prediction network and obtaining a first text feature sample corresponding to a text sample of a first prediction dimension, and a first truthfulness label score of the first text feature sample. In one example, the obtaining the truthfulness prediction network corresponding to each prediction dimension includes obtaining a first truthfulness score based on the initial prediction network being applied to the first text feature sample, obtaining a truthfulness prediction network corresponding to the first prediction dimension based on the initial prediction network being trained with reference to the first truthfulness score and the first truthfulness label score, and obtaining a (j−1)^{th} truthfulness score corresponding to a text sample of a (j−1)^{th} prediction dimension. In one example, the obtaining the truthfulness prediction network corresponding to each prediction dimension includes obtaining a truthfulness prediction network corresponding to a j^{th} prediction dimension based on the initial prediction network being trained with reference to the (j−1)^{th} truthfulness score. In one example, j corresponds to a positive integer ranging from 2 to M.

In an example, in an application scenario of multi-dimensional truthfulness prediction for online news, a general deep-learning classification model is configured for text truthfulness prediction. Text sample: a news article collected on a network. Feature extraction: A text sample is preprocessed and features such as TF-IDF and word embedding are extracted. First prediction dimension: content truthfulness: obtain the first text feature sample and the truthfulness label score: select a news sample related to content truthfulness, such as a news health statement. Feature extraction is performed on the news, to obtain the first text feature sample. A truthfulness label score is allocated to each sample, and these scores are usually generated by experts or manual marking. Text sample 1: a piece of news about effect of a virus. First text feature sample 1: a feature vector extracted by using TF-IDF. First truthfulness label score 1:0.8 (indicating that the news is considered truthful). Truthfulness prediction is performed on the first text feature sample by using the initial prediction network, to obtain the first truthfulness score. Assuming that for the first text feature sample 1, an outputted truthfulness score of the initial prediction network is 0.75, a loss value such as a cross-entropy loss is calculated with reference to the first truthfulness score and the first truthfulness label score. The initial prediction network is trained by using back propagation and gradient descent, to optimize a network parameter. (j−1)^{th} prediction dimension: source reliability, logical consistency, and the like. For each subsequent prediction dimension j, the following operations are performed: obtaining a text sample and a truthfulness score in the (j−1)^{th} prediction dimension; and extracting, by using a text sample the same as that in the previous operation, a feature related to the (j−1)^{th} prediction dimension. A manually marked truthfulness score in the (j−1)^{th} prediction dimension is obtained. The truthfulness prediction network in the j^{th} prediction dimension is trained: The initial prediction network is further trained based on the text sample and the truthfulness score in the (j−1)^{th} prediction dimension. For each sample, a loss value is calculated and a network parameter is updated. Finally, a dedicated prediction network is obtained for each prediction dimension. A dedicated truthfulness prediction network is independently trained for each prediction dimension, and each network is dedicated to a corresponding truthfulness evaluation standard. This can enhance the performance of each dimension receiving sufficient attention and optimization, thereby achieving higher accuracy and reliability in a multi-dimensional truthfulness detection task.

In some embodiments, 2≤j≤M, and M indicates a quantity of prediction dimensions.

In some embodiments, feature check may be performed on the (i−1)^{th} initial text feature based on the (i−1)^{th} truthfulness prediction result, to obtain the (i−1)^{th} target text feature in the following manner: When the (i−1)^{th} truthfulness prediction result indicates that the to-be-processed text is not truthful in a corresponding prediction dimension, feature correction is performed on the (i−1)^{th} initial text feature, to obtain the (i−1)^{th} target text feature. When each (i−1)^{th} truthfulness prediction result indicates that the to-be-processed text is truthful in a corresponding prediction dimension, the (i−1)^{th} initial text feature is determined as the (i−1)^{th} target text feature.

In an example, the (i−1)^{th} truthfulness prediction result is in one-to-one correspondence with prediction dimensions, the prediction dimensions include a prediction dimension A, a prediction dimension B, and a prediction dimension C, and the (i−1)^{th} truthfulness prediction result includes a prediction result corresponding to the prediction dimension A, a prediction result corresponding to the prediction dimension B, and a prediction result corresponding to the prediction dimension C. The prediction result corresponding to the prediction dimension A indicates that the to-be-processed text is not truthful in the prediction dimension A, the prediction result corresponding to the prediction dimension B indicates that the to-be-processed text is truthful in the prediction dimension B, and the prediction result corresponding to the prediction dimension C indicates that the to-be-processed text is not truthful in the prediction dimension C. That is, the (i−1)^{th} truthfulness prediction result indicates that the to-be-processed text is not truthful in the corresponding prediction dimension. In this case, feature correction needs to be performed on the (i−1)^{th} initial text feature, to obtain the (i−1)^{th} target text feature.

In an example, the (i−1)^{th} truthfulness prediction result is in one-to-one correspondence with prediction dimensions, the prediction dimensions include a prediction dimension A, a prediction dimension B, and a prediction dimension C, and the (i−1)^{th} truthfulness prediction result includes a prediction result corresponding to the prediction dimension A, a prediction result corresponding to the prediction dimension B, and a prediction result corresponding to the prediction dimension C. The prediction result corresponding to the prediction dimension A indicates that the to-be-processed text is truthful in the prediction dimension A, the prediction result corresponding to the prediction dimension B indicates that the to-be-processed text is truthful in the prediction dimension B, and the prediction result corresponding to the prediction dimension C indicates that the to-be-processed text is truthful in the prediction dimension C. That is, the (i−1)^{th} truthfulness prediction result indicates that the to-be-processed text is truthful in the corresponding prediction dimensions. In this case, the (i−1)^{th} initial text feature may be directly determined as the (i−1)^{th} target text feature.

In this way, when a truthfulness prediction result indicates that the to-be-processed text may not be truthful in a particular prediction dimension, feature correction can beneficially improve accuracy of text truthfulness detection. Targeted adjustment is performed on the (i−1)^{th} initial text feature, to obtain the (i−1)^{th} target text feature, so that feature impact inconsistent with a prediction result can be effectively removed or alleviated, and subsequent feature encoding and network training can focus more on truthful text information. When it indicates that the to-be-processed text is truthful in all the prediction dimensions, the (i−1)^{th} initial text feature is kept unchanged, to help keep important information of the text and avoid unnecessary feature distortion. Such a dynamic feature processing method not only improves robustness of a model, but also optimizes an ability of the model to recognize a truthful text, and finally significantly improves performance and reliability of truthfulness detection.

In some embodiments, operation 1012 may be implemented in the following manner: The i^{th} feature encoding network is invoked, and feature encoding is performed on the to-be-processed text based on the (i−1)^{th} target text feature, to obtain the i^{th} initial text feature.

In some embodiments, before the i^{th} feature encoding network is invoked, feature check is performed on the (i−1)^{th} initial text feature, to obtain the (i−1)^{th} target text feature. Then, the i^{th} feature encoding network is invoked, and feature encoding is performed on the to-be-processed text based on the (i−1)^{th} target text feature, to obtain the i^{th} initial text feature, so that feature check is performed on a plurality of feature encoding networks layer by layer, to enhance the performance of an input of each layer of feature encoding network corresponding to a target text feature obtained after strict feature check is performed. Therefore, the feature encoding networks can gradually optimize feature encoding of the to-be-processed text, to more effectively improve accuracy of feature encoding.

Operation 1013: Determine an N^{th} initial text feature as the initial text feature of the to-be-processed text. In one example, the obtaining the initial text feature of the to-be-processed text includes determining the N^{th} initial text feature as the initial text feature of the to-be-processed text. In some examples, i ranges from 2 to N.

In an example, as shown in FIG. 5, the N^{th} initial text feature (that is, an output of the N^{th} feature encoding network 5n) is determined as the initial text feature of the to-be-processed text.

In this way, before the i^{th} feature encoding network is invoked, feature check is performed on the (i−1)^{th} initial text feature, to obtain the (i−1)^{th} target text feature. Then, the i^{th} feature encoding network is invoked, and feature encoding is performed on the to-be-processed text based on the (i−1)^{th} target text feature, to obtain the i^{th} initial text feature, so that feature check is performed on a plurality of feature encoding networks layer by layer, to enhance the performance of an input of each layer of feature encoding network corresponding to a target text feature obtained after strict feature check is performed. Therefore, the feature encoding networks can gradually optimize feature encoding of the to-be-processed text, to more effectively improve accuracy of feature encoding.

Operation 102: Perform truthfulness prediction on the logic of the to-be-processed text in at least one prediction dimension based on the initial text feature, to obtain a truthfulness prediction result of the to-be-processed text in each prediction dimension. In one example, one or more truthfulness prediction results of the to-be-processed text in one or more prediction dimensions are obtained. The one or more truthfulness prediction results correspond to one or more truthfulness predictions of logic of the to-be-processed text in the one or more prediction dimensions based on the initial text feature.

In some embodiments, the truthfulness prediction may be implemented by using truthfulness prediction networks. The truthfulness prediction networks are in one-to-one correspondence with the prediction dimensions. That is, different prediction dimensions correspond to different truthfulness prediction networks. Network structures of the truthfulness prediction networks in the different prediction dimensions are the same, and network parameters are different. The network structure of the truthfulness prediction network may include a convolutional layer, a pooling layer, and a normalization layer.

In some embodiments, the prediction dimensions indicate logical dimensions of the to-be-processed text. The prediction dimensions are in one-to-one correspondence with the logical dimensions of the to-be-processed text. The logical dimensions of the to-be-processed text include a plurality of language logic types such as life literacy logic and grammar logic. For example, the life literacy logic includes: a refrigerator is smaller than an elephant, and there is no oxygen on the moon.

In some embodiments, the truthfulness prediction and the prediction dimension are concepts in the field of natural language processing (NLP), and are usually configured for evaluating truthfulness or credibility of text content in a particular aspect. Truthfulness prediction is predicting truthfulness of a piece of text content by using a machine learning model or algorithm. Such prediction is usually based on factors such as syntax, semantics, and a context of a text and a relationship with other known information. An objective of truthfulness prediction is to determine whether text content satisfies facts, whether text content is deceptive, or whether text content includes inaccurate information.

In an example, the prediction dimensions are different aspects or attributes considered during truthfulness prediction. These dimensions may be diversified, and the following are some related examples of the prediction dimensions: content truthfulness: evaluating whether text content is based on facts, for example, accuracy of a news article; source reliability: evaluating credibility of a text source, for example, determining whether a social media account is reliable; sentiment consistency: evaluating whether a text sentiment is consistent with a genuine sentiment of an author, for example, detecting an untruthful comment; logical consistency: evaluating whether logic in a text is coherent and free of clear contradictions; and contextual relevance: evaluating whether text content is related to a given context.

In an example, in truthfulness prediction of a news article, if a prediction result in the content truthfulness dimension indicates that the article includes untruthful information, it may be concluded that the article is not truthful in the content truthfulness dimension.

In an example, in an application scenario of news verification, prediction dimensions are content truthfulness, source reliability, and logical consistency. A to-be-processed text is financial news about a performance report of a company. Truthfulness prediction: content truthfulness: It is found, by checking facts, that data in the news is inconsistent with an officially published performance report, and a prediction result is that the news is not truthful. Source reliability: A news source is a well-known financial media, and a prediction result is that the news is truthful. Logical consistency: Data analysis and logical reasoning in the news have no clear contradiction, and a prediction result is that the news is truthful.

In an example, in an application scenario of anti-fraud in social media, prediction dimensions may include: sentiment consistency and contextual relevance. A to-be-processed text may be a social media comment about experience of a product. Truthfulness prediction: sentiment consistency: Sentiment analysis of the comment shows that a user's evaluation of the product is unusually positive, and is inconsistent with other comments in a purchase record of the user, and a prediction result is that the comment is not truthful. Contextual relevance: Comment content does not match a feature and a context of the product, and a prediction result is that the comment is not truthful.

In an example, in an application scenario of academic integrity detection, prediction dimensions are content truthfulness and originality. A to-be-processed text is a submitted academic paper. Truthfulness prediction: content truthfulness: It is found, by comparing with academic databases, that some data in the paper is tampered with, and a prediction result is that the paper is not truthful. Originality: It is found, through plagiarism detection software, that a large piece of content in the paper is copied from other publications, and a prediction result is that the paper is not truthful.

In an example, in an application scenario of online language detection, prediction dimensions are content truthfulness, source reliability, and logical consistency. A to-be-processed text is a widely circulated online post. Truthfulness prediction: Content truthfulness: Information mentioned in the post cannot be authenticated by a reliable source, and a prediction result is that the post is not truthful. Source reliability: An account history of a poster includes a plurality of behaviors of publishing untruthful information, and a prediction result is that the post is not truthful. Logical consistency: An argument in the post has a clear logical flaw, and a prediction result is that the post is not truthful.

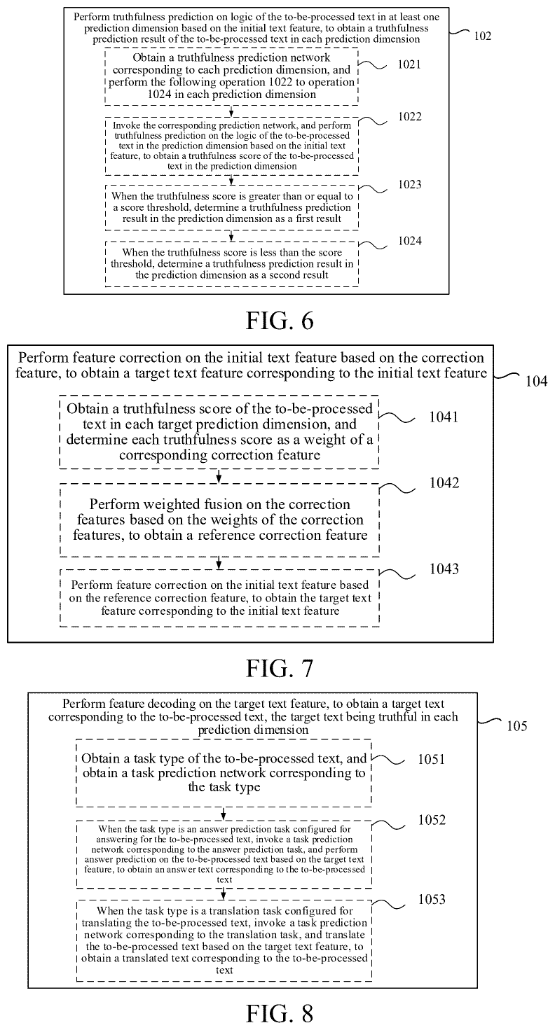

In some embodiments, FIG. 6 is a schematic flowchart of a text processing method according to an embodiment of this disclosure. Operation 102 shown in FIG. 3 may be implemented by performing operation 1021 to operation 1024 shown in FIG. 6. In one example, the feature encoding is based on at least one feature encoding network.

Operation 1021: Obtain a truthfulness prediction network corresponding to each prediction dimension, and perform the following operation 1022 to operation 1024 in each prediction dimension.

In some embodiments, the truthfulness prediction may be implemented by using truthfulness prediction networks. The truthfulness prediction networks are in one-to-one correspondence with the prediction dimensions. That is, different prediction dimensions correspond to different truthfulness prediction networks. Network structures of the truthfulness prediction networks in the different prediction dimensions are the same, and network parameters are different. The network structure of the truthfulness prediction network may include a convolutional layer, a pooling layer, and a normalization layer.

In some embodiments, when there is one prediction dimension, the truthfulness prediction network corresponding to each prediction dimension may be obtained in the following manner: An initial prediction network is obtained, and a plurality of text feature samples corresponding to a text sample and truthfulness label scores of the text feature samples are obtained. For each text feature sample, the initial prediction network is invoked, truthfulness prediction is performed on logic of the text sample of the prediction dimension based on the text feature sample, to obtain a truthfulness score corresponding to the text feature sample, and a loss value corresponding to the text feature sample is determined with reference to the truthfulness score and the corresponding truthfulness label score. The initial prediction network is trained based on the loss value corresponding to each text feature sample, to obtain the truthfulness prediction network corresponding to the prediction dimension.

In one example, for each text feature sample, a truthfulness score is obtained based on the initial prediction network being applied to the text feature sample. In one example, for each text feature sample, a loss value corresponding to the text feature sample is determined with reference to the truthfulness score and the corresponding truthfulness label score. In one example, the truthfulness prediction network corresponding to the prediction dimension is obtained based on the initial prediction network being trained with reference to the loss value corresponding to each text feature sample.

In an example, in an application scenario of comment truthfulness detection on a social media platform, the initial prediction network may be a deep learning-based classification model, configured for text truthfulness prediction. The text feature sample may be a feature vector obtained by performing preprocessing and feature extraction on a comment collected on the social media platform. The truthfulness label score may be a truthfulness label of each comment, is usually manually marked, and indicates whether the comment is truthful or untruthful. Text sample 1: comment content “This product is really very good, and I like it very much!”. Text feature sample 1: a feature vector obtained through feature extraction, such as a bag-of-words model or word embedding. Truthfulness label score 1:0.9 (indicating that the comment is probably truthful). A large quantity of social media comments and corresponding truthfulness label scores are collected. The comments are preprocessed, to extract text features, to obtain a text feature sample set and a corresponding truthfulness label score set. For each text feature sample, the initial prediction network is invoked to perform truthfulness prediction. It is assumed that for the text feature sample 1, a truthfulness score provided by the initial prediction network is 0.85. A loss function (such as a cross entropy loss or a mean square error) is configured for calculating a difference between the predicted value and the truthfulness label value. For the text feature sample 1, a loss value may be calculated as (0.9-0.85)\hat{ }2. The initial prediction network is trained by using loss values of all text feature samples. A network parameter is adjusted by using optimization algorithms such as back propagation and gradient descent, to reduce the loss value. After sufficient training iterations, the initial prediction network may gradually learn and improve a prediction capability of the initial prediction network. Finally, a trained network is a truthfulness prediction network for a particular prediction dimension.

In some embodiments, the truthfulness scores are in one-to-one correspondence with the text feature samples, and the text feature samples are in one-to-one correspondence with the truthfulness label scores. The loss value corresponding to the text feature sample may be determined with reference to the truthfulness score and the corresponding truthfulness label score in the following manner: The truthfulness label score of the text feature sample is subtracted from the truthfulness score of the text feature sample, to obtain the loss value corresponding to the text feature sample.

In an example, an expression of the loss value of the text feature sample may be:

$$L 1 = F 1 - F 2 \qquad ( 1 )$$

L1 indicates the loss value of the text feature sample, F1 indicates the truthfulness score of the text feature sample, and F2 indicates the truthfulness label score of the text feature sample.

In some embodiments, the plurality of text feature samples corresponding to the text sample may be obtained in the following manner: The text sample is obtained, and feature encoding is performed on the text sample, to obtain an initial text feature of the text sample. Feature splitting is performed on the initial text feature of the text sample, to obtain the plurality of text feature samples corresponding to the text sample.

In some embodiments, feature splitting may be performed on the initial text feature of the text sample, to obtain the plurality of text feature samples corresponding to the text sample in the following manner: The following processing is separately performed on each feature character in the initial text feature: A feature character is determined as a target feature character, and the target feature character is combined in various manners with another feature character in the initial text feature, to obtain at least one text feature sample corresponding to the target feature character.

In some embodiments, the text feature samples corresponding to the text sample are all sub-features of the initial text feature of the text sample.

In an example, the initial text feature may be 1234567, and the plurality of text feature samples corresponding to the text sample may be 12, 123, 1234, 12345, 123456, 23, 234, and the like.

In this way, feature encoding is performed on the text sample, to obtain the initial text feature of the text sample, and feature splitting is performed on the initial text feature of the text sample, to obtain the plurality of text feature samples corresponding to the text sample, thereby effectively expanding a quantity of training samples of the initial prediction network, and effectively improving prediction performance of a truthfulness prediction network obtained through training.

In some embodiments, when there are a plurality of prediction dimensions, a truthfulness prediction network corresponding to each prediction dimension may be obtained in the following manner: An initial prediction network is obtained, and a first text feature sample corresponding to a text sample of a first prediction dimension, and a first truthfulness label score of the first text feature sample are obtained. The initial prediction network is invoked, truthfulness prediction is performed on logic of the text sample of the first prediction dimension based on the first text feature sample, to obtain a first truthfulness score, and the initial prediction network is trained with reference to the first truthfulness score and the first truthfulness label score, to obtain a truthfulness prediction network corresponding to the first prediction dimension. j is iterated over, to perform the following processing: obtaining a (j−1)^{th} truthfulness score corresponding to a text sample of a (j−1)^{th} prediction dimension, and the initial prediction network is trained based on the (j−1)^{th} truthfulness score, to obtain a truthfulness prediction network corresponding to a j^{th} prediction dimension.

In some embodiments, 2≤j≤M, and M indicates a quantity of prediction dimensions.

In an example, in an application scenario of multi-dimensional truthfulness prediction for online news, a general deep-learning classification model is configured for text truthfulness prediction. Text sample: a news article collected on a network. Feature extraction: A text sample is preprocessed and features such as TF-IDF and word embedding are extracted. First prediction dimension: content truthfulness: obtain the first text feature sample and the truthfulness label score: select a news sample related to content truthfulness, such as a news health statement. Feature extraction is performed on the news, to obtain the first text feature sample. A truthfulness label score is allocated to each sample, and these scores are usually generated by experts or manual marking. Text sample 1: a piece of news about effect of a virus. First text feature sample 1: a feature vector extracted by using TF-IDF. First truthfulness label score 1:0.8 (indicating that the news is considered truthful). Truthfulness prediction is performed on the first text feature sample by using the initial prediction network, to obtain the first truthfulness score. Assuming that for the first text feature sample 1, an outputted truthfulness score of the initial prediction network is 0.75, a loss value such as a cross-entropy loss is calculated with reference to the first truthfulness score and the first truthfulness label score. The initial prediction network is trained by using back propagation and gradient descent, to optimize a network parameter. (j−1)^{th} prediction dimension: source reliability, logical consistency, and the like. For each subsequent prediction dimension j, the following operations are performed: obtaining a text sample and a truthfulness score in the (j−1)^{th} prediction dimension; and extracting, by using a text sample the same as that in the previous operation, a feature related to the (j−1)^{th} prediction dimension. A manually marked truthfulness score in the (j−1)^{th} prediction dimension is obtained. The truthfulness prediction network in the j^{th} prediction dimension is trained: The initial prediction network is further trained based on the text sample and the truthfulness score in the (j−1)^{th} prediction dimension. For each sample, a loss value is calculated and a network parameter is updated. Finally, a dedicated prediction network is obtained for each prediction dimension. A dedicated truthfulness prediction network is independently trained for each prediction dimension, and each network is dedicated to a corresponding truthfulness evaluation standard. This can enhance the performance of each dimension receiving sufficient attention and optimization, thereby achieving higher accuracy and reliability in a multi-dimensional truthfulness detection task.

In some embodiments, the first text feature sample corresponding to the text sample of the first prediction dimension may be obtained in the following manner: The text sample of the first prediction dimension is obtained, and feature encoding is performed on the text sample of the first prediction dimension, to obtain an initial text feature of the text sample of the first prediction dimension. In addition, feature splitting is performed on the initial text feature of the text sample of the first prediction dimension, to obtain a plurality of first text feature samples of the text sample of the first prediction dimension.

In some embodiments, the initial prediction network may be trained with reference to the first truthfulness score and the first truthfulness label score, to obtain the truthfulness prediction network corresponding to the first prediction dimension in the following manner: A difference between the first truthfulness score and the first truthfulness label score is determined as a loss value in the first prediction dimension, and the initial prediction network is trained based on the loss value in the first prediction dimension, to obtain the truthfulness prediction network corresponding to the first prediction dimension.

In some embodiments, the (j−1)^{th} truthfulness score corresponding to the text sample of the (j−1)^{th} prediction dimension is obtained, and the initial prediction network is trained based on the (j−1)^{th} truthfulness score, to obtain the truthfulness prediction network corresponding to the j^{th} prediction dimension, so that the truthfulness prediction network corresponding to the j^{th} prediction dimension can make effective use of a network parameter of a truthfulness prediction network corresponding to the (j−1)^{th} prediction dimension, and a prediction direction of the truthfulness prediction network corresponding to the j^{th} prediction dimension keeps being orthogonal to a prediction direction of the truthfulness prediction network corresponding to the (j−1)^{th} prediction dimension, thereby effectively improving prediction independence between truthfulness prediction networks in different prediction dimensions.

In an example, the first truthfulness score corresponding to the text sample of the first prediction dimension is obtained, and the initial prediction network is trained based on the first truthfulness score, to obtain a truthfulness prediction network corresponding to a second prediction dimension. A second truthfulness score corresponding to a text sample of the second prediction dimension is obtained, and the initial prediction network is trained based on the second truthfulness score, to obtain a truthfulness prediction network corresponding to a third prediction dimension.

In some embodiments, the initial prediction network may be trained based on the (j−1)^{th} truthfulness score, to obtain the truthfulness prediction network corresponding to the j^{th} prediction dimension in the following manner: A j^{th} text feature sample corresponding to a text sample of the j^{th} prediction dimension and a j^{th} truthfulness label score of the j^{th} text feature sample are obtained. An initial prediction network is invoked, and truthfulness prediction is performed on logic of the text sample of the j^{th} prediction dimension based on the j^{th} text feature sample, to obtain a j^{th} truthfulness score. A first loss value is determined with reference to the j^{th} truthfulness score and the (j−1)^{th} truthfulness score, and a second loss value is determined with reference to the j^{th} truthfulness score and the j^{th} truthfulness label score. The initial prediction network is trained with reference to the first loss value and the second loss value, to obtain the truthfulness prediction network corresponding to the j^{th} prediction dimension.

In some embodiments, an expression of the first loss value may be:

$${L}_{orth} = {\sum }_{t = 1}^{k} {\sum }_{r = 1}^{i - 1} {\vert 〈 {θ}_{t} , {θ}_{r} 〉 \vert}_{1} \qquad ( 2 )$$

Lₒᵣₜₕ indicates the first loss value, θₜ indicates the j^{th} truthfulness score, and θᵣ indicates the (j−1)^{th} truthfulness score.

In some embodiments, an expression of the second loss value may be:

$${L}_{2} = F 3 - F 4 \qquad ( 3 )$$

L₂ indicates the second loss value, F3 indicates the j^{th} truthfulness score, and F4 indicates the j^{th} truthfulness label score.

In some embodiments, the initial prediction network may be trained with reference to the first loss value and the second loss value, to obtain the truthfulness prediction network corresponding to the j^{th} prediction dimension in the following manner: The first loss value and the second loss value are summed, to obtain a total loss of the j^{th} prediction dimension, and the initial prediction network is trained based on the total loss, to obtain the truthfulness prediction network corresponding to the j^{th} prediction dimension.

In this way, the (j−1)^{th} truthfulness score corresponding to the text sample of the (j−1)^{th} prediction dimension is obtained, and the initial prediction network is trained based on the (j−1)^{th} truthfulness score, to obtain the truthfulness prediction network corresponding to the j^{th} prediction dimension, so that the truthfulness prediction network corresponding to the j^{th} prediction dimension can make effective use of a network parameter of a truthfulness prediction network corresponding to the (j−1)^{th} prediction dimension, and a prediction direction of the truthfulness prediction network corresponding to the j^{th} prediction dimension keeps being orthogonal to a prediction direction of the truthfulness prediction network corresponding to the (j−1)^{th} prediction dimension, thereby effectively improving prediction independence between truthfulness prediction networks in different prediction dimensions.

Operation 1022: Invoke the corresponding truthfulness prediction network, and perform truthfulness prediction on the logic of the to-be-processed text in the prediction dimension based on the initial text feature, to obtain a truthfulness score of the to-be-processed text in the prediction dimension. In one example, for each prediction dimension, a truthfulness score of the to-be-processed text in the respective prediction dimension is determined based on the corresponding truthfulness prediction network in the respective prediction dimension being applied to the initial text feature.

In some embodiments, operation 1022 may be implemented in the following manner: For each prediction dimension, the truthfulness prediction network corresponding to the prediction dimension is invoked, and truthfulness prediction is performed on the logic of the to-be-processed text in the prediction dimension based on the initial text feature, to obtain the truthfulness score of the to-be-processed text in the prediction dimension.

In an example, the prediction dimensions include a prediction dimension A, a prediction dimension B, and a prediction dimension C. A truthfulness prediction network corresponding to the prediction dimension A is invoked, and truthfulness prediction is performed on the logic of the to-be-processed text in the prediction dimension A based on the initial text feature, to obtain a truthfulness score of the to-be-processed text in the prediction dimension A. A truthfulness prediction network corresponding to the prediction dimension B is invoked, and truthfulness prediction is performed on the logic of the to-be-processed text in the prediction dimension B based on the initial text feature, to obtain a truthfulness score of the to-be-processed text in the prediction dimension B. A truthfulness prediction network corresponding to the prediction dimension C is invoked, and truthfulness prediction is performed on the logic of the to-be-processed text in the prediction dimension C based on the initial text feature, to obtain a truthfulness score of the to-be-processed text in the prediction dimension C.

Operation 1023: When the truthfulness score is greater than or equal to a score threshold, determine the truthfulness prediction result in the prediction dimension as a first result. In one example, for each prediction dimension, when the truthfulness score is greater than or equal to a score threshold, a truthfulness prediction result is determined as a first result indicating that the to-be-processed text is truthful in the respective prediction dimension.

In some embodiments, the first result indicates that the to-be-processed text is truthful in the prediction dimension.

In some embodiments, the score threshold may be specifically set according to an actual application scenario. The score threshold is configured for determining whether the to-be-processed text is truthful in the prediction dimension.

Operation 1024: When the truthfulness score is less than the score threshold, determine the truthfulness prediction result in the prediction dimension as a second result. In one example, for each prediction dimension, when the truthfulness score is less than the score threshold to the score threshold, the truthfulness prediction result is determined as a second result indicating that the to-be-processed text is not truthful in the respective prediction dimension.

In some embodiments, the second result indicates that the to-be-processed text is not truthful in the prediction dimension.

In some embodiments, after operation 102, a target text may be further determined in the following manner: When the truthfulness prediction results in the prediction dimensions all indicate that the to-be-processed text is truthful in the corresponding prediction dimensions, feature decoding is performed on the initial text feature, to obtain the target text corresponding to the to-be-processed text.

In some embodiments, when the truthfulness prediction results in the prediction dimensions all indicate that the to-be-processed text is truthful in a corresponding prediction dimension, it indicates that a text obtained by performing feature decoding on the initial text feature can be truthful in each prediction dimension. In this case, the text obtained by performing feature decoding on the initial text feature may be determined as the target text corresponding to the to-be-processed text.

In this way, when a truthfulness prediction result indicates that the to-be-processed text may not be truthful in a particular prediction dimension, feature correction can beneficially improve accuracy of text truthfulness detection. Targeted adjustment is performed on the (i−1)^{th} initial text feature, to obtain the (i−1)^{th} target text feature, so that feature impact inconsistent with a prediction result can be effectively removed or alleviated, and subsequent feature encoding and network training can focus more on truthful text information. When it indicates that the to-be-processed text is truthful in all the prediction dimensions, the (i−1)^{th} initial text feature is kept unchanged, to help keep important information of the text and avoid unnecessary feature distortion. Such a dynamic feature processing method not only improves robustness of a model, but also optimizes an ability of the model to recognize a truthful text, and finally significantly improves performance and reliability of truthfulness detection.

Operation 103: For each prediction dimension, when the truthfulness prediction result in the prediction dimension indicates that the to-be-processed text is not truthful in the prediction dimension, obtain a correction feature of the initial text feature in the prediction dimension. In one example, for each of the one or more prediction dimensions, a correction feature of the initial text feature in the respective prediction dimension is obtained when the corresponding truthfulness prediction result indicates that the to-be-processed text is not truthful in the respective prediction dimension.

In an example, the prediction dimensions are in one-to-one correspondence with the truthfulness prediction results. When the truthfulness prediction result indicates that the to-be-processed text is not truthful in the prediction dimension A, a correction feature of the initial text feature in the prediction dimension A is obtained. When the truthfulness prediction result indicates that the to-be-processed text is not truthful in the prediction dimension B, a correction feature of the initial text feature in the prediction dimension B is obtained.

In some embodiments, the correction feature is configured for correcting a corresponding feature dimension of the initial text feature, so that a text obtained by performing feature decoding on the corrected initial text feature can be truthful in the corresponding feature dimension.

In an example, in an application scenario of detecting reliability of a news source, a prediction dimension is source reliability, a to-be-processed text is a news report from an unknown source. Truthfulness prediction result: The prediction result indicates that the news source has low reliability. Correction feature: an initial text feature is adjusted, and a signal related to source reliability is added, such as a domain reputation and a historical release record of a news source, to improve a feature weight of a text having an unreliable source.

In some embodiments, the correction feature of the initial text feature in the corresponding prediction dimension may be obtained in the following manner: A dimension-feature mapping relationship is obtained; when the truthfulness prediction result indicates that the to-be-processed text is not truthful in the corresponding prediction dimension, the corresponding prediction dimension is determined as a target prediction dimension; the dimension-feature mapping relationship is queried for a target index entry including the target prediction dimension; and a feature in the target index entry is determined as a correction feature in the target prediction dimension.

Operation 104: Perform feature correction on the initial text feature based on the correction feature, to obtain a target text feature corresponding to the initial text feature. In one example, a target text feature corresponding to the initial text feature is obtained based on the correction feature for each of the one or more prediction dimensions.

In some embodiments, the feature correction is configured for correcting the initial text feature, so that feature decoding is performed on the obtained target text feature, and the obtained target text is truthful in each prediction dimension.

In some embodiments, when there is one correction feature, the correction feature is used as a reference correction feature, and operation 104 shown in FIG. 3 may be implemented in the following manner: Feature correction is performed on the initial text feature based on the reference correction feature, to obtain the target text feature corresponding to the initial text feature.

In some embodiments, FIG. 7 is a schematic flowchart of a text processing method according to an embodiment of this disclosure. The correction features are in one-to-one correspondence with the target prediction dimensions, and the to-be-processed text is not truthful in the target prediction dimensions. When there are a plurality of correction features, operation 104 shown in FIG. 3 may be implemented by performing operation 1041 to operation 1043 shown in FIG. 7.

Operation 1041: Obtain a truthfulness score of the to-be-processed text in each target prediction dimension, and determine each truthfulness score as a weight of a corresponding correction feature.

In an example, the correction features are in one-to-one correspondence with the target prediction dimensions. The target prediction dimensions include a prediction dimension 1, a prediction dimension 2, and a prediction dimension 3. A truthfulness score 11 of the to-be-processed text in the target prediction dimension 1 is obtained, a truthfulness score 21 of the to-be-processed text in the target prediction dimension 2 is obtained, and a truthfulness score 31 of the to-be-processed text in the target prediction dimension 3 is obtained. The truthfulness score 11 is determined as a weight of a correction feature corresponding to the target prediction dimension 1, the truthfulness score 21 is determined as a weight of a correction feature corresponding to the target prediction dimension 2, and the truthfulness score 31 is determined as a weight of a correction feature corresponding to the target prediction dimension 3.

Operation 1042: Perform weighted fusion on the correction features based on the weights of the correction features, to obtain the reference correction feature.

In an example, an expression of the reference correction feature may be:

$$T = {ω}_{1} {T}_{1} + {ω}_{2} {T}_{2} + … {ω}_{t} {T}_{t} \qquad ( 4 )$$

T indicates the reference correction feature, ω₁ to ωₜ indicate weights of the correction features, and T₁ to Tₜ indicate the correction features.

Operation 1043: Perform feature correction on the initial text feature based on the reference correction feature, to obtain a target text feature corresponding to the initial text feature.

In some embodiments, operation 1043 may be implemented in the following manner: A feature dimension of the initial text feature and a feature dimension of the reference correction feature are obtained; when the feature dimension of the initial text feature is different from the feature dimension of the reference correction feature, the feature dimension of the reference correction feature is adjusted, to obtain a target correction feature; when the feature dimension of the initial text feature is the same as the feature dimension of the reference correction feature, the reference correction feature is determined as the target correction feature; correction strength of the initial text feature is determined based on a quantity of correction features, the correction strength being in positive correlation with the quantity of correction features; and a product of the correction strength and the target correction feature is determined as a fusion feature, and the initial text feature and the fusion feature are added, to obtain the target text feature.

In some embodiments, when the feature dimension of the initial text feature is different from the feature dimension of the reference correction feature, the feature dimension of the reference correction feature is adjusted, to obtain the target correction feature. A feature dimension of the target correction feature is the same as the feature dimension of the initial text feature.

In an example, an expression of the target text feature may be:

$$Q = {Q}_{1} + {Q}_{2} \qquad ( 5 )$$

Q indicates the target text feature, Q₁ indicates the initial text feature, and Q₂ indicates the fusion feature.

In an example, an expression of the fusion feature may be:

$${Q}_{2} = α {T}_{m} \qquad ( 6 )$$

Q₂ indicates the fusion feature, a indicates correction strength, and Tₘ indicates the target correction feature.

In this way, a corresponding feature dimension of the initial text feature is corrected, so that a text obtained by performing feature decoding on the corrected initial text feature can be truthful in the corresponding feature dimension, to more effectively improve accuracy of the generated target text.

In this way, a weight of a feature is dynamically adjusted by evaluation on text truthfulness according to each prediction dimension, to reduce or exclude possible untruthful or misleading information while keeping key information. Weighted fusion is performed on the correction features to obtain the reference correction feature, so that text truthfulness can be reflected more accurately, to accurately correct the initial text feature based on the reference correction feature. Finally, the obtained target text feature not only better represents text truthfulness, but also improves subsequent performance and reliability of a truthfulness prediction model, and can be more effective and robust when complex and diversified text data is processed.

Operation 105: Perform feature decoding on the target text feature, to obtain the target text corresponding to the to-be-processed text, the target text being truthful in each prediction dimension. In one example, a target text corresponding to the to-be-processed text is obtained by processing circuitry based on feature decoding of the target text feature.

In some embodiments, FIG. 8 is a schematic flowchart of a text processing method according to an embodiment of this disclosure. Operation 105 shown in FIG. 3 may be implemented by performing operation 1051 to operation 1053 shown in FIG. 8.

Operation 1051: Obtain a task type of the to-be-processed text, and obtain a task prediction network corresponding to the task type.

In some embodiments, the task type of the to-be-processed text may include various natural language processing task types such as a translation task type, a public opinion detection task type, an automatic digest task type, an opinion extraction task type, a text classification task type, a question and answering task type, a text semantic comparison task type, and a speech recognition task type. The task types are in one-to-one correspondence with task prediction networks.

Operation 1052: When the task type is an answer prediction task configured for answering for the to-be-processed text, invoke a task prediction network corresponding to the answer prediction task, and perform answer prediction on the to-be-processed text based on the target text feature, to obtain an answer text corresponding to the to-be-processed text. In one example, when the task type corresponds to an answer prediction task indicating answering the to-be-processed text, an answer text corresponding to the to-be-processed text is obtained based on the task prediction network being applied to the target text feature, the answer text being truthful in each prediction dimension.

In some embodiments, the answer text is truthful in each prediction dimension.

In some embodiments, a network structure of the task prediction network may include a convolutional layer and a prediction layer. The task prediction network corresponding to the answer prediction task may be invoked, and answer prediction may be performed on the to-be-processed text based on the target text feature, to obtain the answer text corresponding to the to-be-processed text in the following manner: The convolutional layer of the task prediction network corresponding to the answer prediction task is invoked, and feature convolution is performed on the target text feature, to obtain a target convolutional feature; and the prediction layer of the task prediction network corresponding to the answer prediction task is invoked, and text prediction is performed on the target text feature, to obtain the answer text corresponding to the to-be-processed text.

In an example, the to-be-processed text is “How old are you today?”, and the answer text corresponding to the to-be-processed text may be “I am 26 years old this year”.

Operation 1053: When the task type is a translation task configured for translating the to-be-processed text, invoke a task prediction network corresponding to the translation task, and translate the to-be-processed text based on the target text feature, to obtain a translated text corresponding to the to-be-processed text. In one example, when the task type corresponds to a translation task indicating translating the to-be-processed text, a translated text corresponding to the to-be-processed text is obtained based on the task prediction network being applied to the target text feature, the translated text being truthful in each prediction dimension.

In some embodiments, the translated text is truthful in each prediction dimension.

In some embodiments, a network structure of the task prediction network may include a convolutional layer and a prediction layer. The task prediction network corresponding to the translation task may be invoked, and the to-be-processed text may be translated based on the target text feature, to obtain the translated text corresponding to the to-be-processed text in the following manner: The convolutional layer of the task prediction network corresponding to the translation task is invoked, and feature convolution is performed on the target text feature, to obtain a target convolutional feature; and the prediction layer of the task prediction network corresponding to the translation task is invoked, and text prediction is performed on the target text feature, to obtain the translated text corresponding to the to-be-processed text.

In an example, the to-be-processed text is “How old are you this year?”, and the translated text corresponding to the to-be-processed text may be “Ni jin nian duo da nian ji le?”.

In this way, feature encoding is performed on the to-be-processed text, to obtain the initial text feature of the to-be-processed text. Truthfulness prediction is performed on the logic of the to-be-processed text in the at least one prediction dimension based on the initial text feature, to obtain the truthfulness prediction result of the to-be-processed text in each prediction dimension. When the truthfulness prediction result indicates that the to-be-processed text is not truthful in a corresponding prediction dimension, a correction feature in the corresponding prediction dimension is obtained. Feature correction is performed on the initial text feature based on the correction feature, to obtain the target text feature corresponding to the initial text feature. Feature decoding is performed on the target text feature, to obtain the target text being truthful in each prediction dimension. In this way, truthfulness prediction is performed on the logic of the to-be-processed text in at least one prediction dimension based on the initial text feature, to obtain the truthfulness prediction result of the to-be-processed text in each prediction dimension. Feature correction is performed on the initial text feature, to obtain the target text feature, and feature decoding is performed on the target text feature, so that the target text is truthful in each prediction dimension, thereby effectively improving accuracy of the target text, and effectively improving accuracy of text processing.

An application of question and answering of embodiments of this disclosure in an actual application scenario is described below.

In recent years, pre-trained language models based on a Transformer have achieved remarkable success in natural language processing tasks. However, these models usually generate untruthful information during a generation task. According to the text processing method provided in embodiments of this disclosure, a multi-directional probe can be configured for identifying a direction pointing to truthfulness in a large model, and intervening in a generation process of a language model, to improve truthfulness of a generated result.

To clarify symbols and background, the following briefly introduces some key elements of a Transformer architecture, and a multi-head attention mechanism (MHA) is regarded as a manner of independently adding, to a residual flow, a vector on which attention weighting is performed.

A core component of the Transformer is a series of Transformer layers of a same size. In this embodiment of this disclosure, a variable 1 represents the layers. Each Transformer layer includes two key modules: one is a multi-head attention (MHA) mechanism, and the other is a standard multi-layer perceptron (MLP) layer. The MHA layer is mainly described in this embodiment of this disclosure, and this is a position generated by TrFr by performing probe training and intervention.

In each Transformer layer, the MHA includes H linear operations, and the MLP is responsible for all non-linear operations. The MHA may be specifically represented as:

$${x}_{l + 1} = {x}_{l} + {\sum }_{h = 1}^{H} {Q}_{l}^{h} A t {t}_{l}^{h} ( {P}_{l}^{h} {x}_{l} ) \qquad ( 7 )$$

$${P}_{l}^{h} ∈ {R}^{D \times D H}$$

activates a flow and maps the flow to low-dimensional head space of a dimension D, and

$${Q}_{l}^{h} ∈ {R}^{D H \times D}$$

maps the flow back to original high-dimensional space. Att is an attention calculation operator, configured for communicating with another input token. The probe training and intervention in this embodiment of this disclosure occur after Att, and before

$${Q}_{l}^{h} ,$$

activation is represented by xₗ∈R^{D}.

The text processing method provided in embodiments of this disclosure is intended to identify a direction pointing to truthfulness in a large model by using a multi-directional probe, and use the multi-directional probe to intervene in a generation process of a large language model, to improve truthfulness of a generated result.

This embodiment of this disclosure is based on the following assumption: When a large model outputs truthful and hallucinating content, internal states are different. Specifically, when a text sequence is input into the large model, a neural network in the large model generates some implicit vector outputs (in this embodiment of this disclosure, a head outputted with multi-head attention is used as a probe for truthfulness of the large model). In this embodiment of this disclosure, a batch of probes are constructed, and it is determined, based on these implicit vector outputs, that currently generated content of the large model is truthful content and hallucination. These probes may further help a model to perform truthfulness intervention on a result generated by the large model, so that the large model can perform a related but more objective and truthful response.

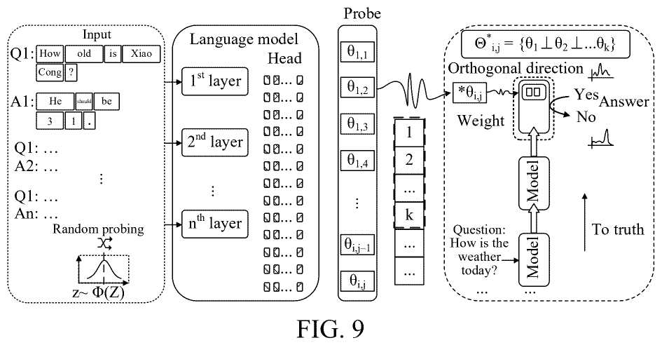

In some embodiments, FIG. 9 is a schematic diagram of a principle of a text processing method according to an embodiment of this disclosure. Localization and intervention are performed by focusing on a smallest state unit, namely, a head of multi-head attention (MHA), in the Transformer. In this embodiment of this disclosure, a plurality of probes are introduced for each head (the first layer, the second layer, . . . , and an n^{th} layer shown in FIG. 9), and orthogonal constraints are enforced between the probes to prevent model collapse. Orthogonality between the probes is maintained by optimizing orthogonal probes and introducing an orthogonality loss function. Studies on internal state probes of the language model show that the language model often has an ability to distinguish lies from truth, but are unable to more effectively generate facts. In this embodiment of this disclosure, a feature is extracted by considering an extended range in the sequence. Specifically, in this embodiment of this disclosure, samples are drawn from a predefined distribution, and the sequence is truncated at different positions to obtain different features, so that a learned direction is more stable and can be generalized to different positions in a generation process. After the training is completed, an orthogonal vector pointing to truthfulness can be obtained. In this embodiment of this disclosure, a final orthogonal vector is calculated by using an exponential decay weight, and the heads are sorted, to obtain a final intervention vector. During intervention at the MHA layer, it is modified to a constant. Because an additional term in each operation is a constant, time complexity of using TrFr is O(1).

In some embodiments, for the probe shown in FIG. 9, for each head, a classifier p_{σ}_{ₖ} is introduced in this embodiment of this disclosure as a probe, and an input is

$${x}_{h}^{l} . {p}_{{θ}_{k}} ( {x}_{h}^{l} ) = sigmoid ( 〈 {θ}_{k} , {x}_{h}^{l} 〉 ) , and {x}_{h}^{l}$$

is a result of l2-norm.

In this embodiment of this disclosure, a plurality of probes are introduced for each head, and orthogonal constraints are enforced between the probes:

$$Θ = \{ {θ}_{1} , {θ}_{2} , … , {θ}_{k} \} , {θ}_{i} ⊥ {θ}_{j} , i \neq j \qquad ( 8 )$$

In this embodiment of this disclosure, an orthogonal probe is optimized, and an orthogonal loss function is introduced:

$${L}_{orth} = {\sum }_{i = 1}^{k} {\sum }_{j = 1}^{i - 1} {\vert 〈 {θ}_{i} , {θ}_{j} 〉 \vert}_{1} \qquad ( 9 )$$

By minimizing a loss, in this embodiment of this disclosure, the probes are encouraged to be orthogonal to each other, to capture different aspects of representation of truthfulness in the model. A total loss function of each probe is:

$${L}_{total} = {L}_{c e} + λ {L}_{o r t h} + μ {L}_{2} \qquad ( 10 )$$

λ and μ are adjusted, so that a balance between accuracy and orthogonality of the probe can be controlled in this embodiment of this disclosure.

In this embodiment of this disclosure, a feature is extracted by considering an extended range in the sequence. Specifically, in this embodiment of this disclosure, samples are drawn from a predefined distribution, and the sequence is truncated at different positions to obtain different features, so that a learned direction is more stable and can be generalized to different positions in a generation process.

In some embodiments, in this embodiment of this disclosure, it is stipulated that D is a question-answer data set about hallucinations, and each question includes incorrect and correct answers. Φ may be a distribution defined in various manners. Transformer is a to-be-intervened generation model in this embodiment of this disclosure.

In an example, pseudocode for extracting a feature by considering the extended range in the sequence provided in this embodiment of this disclosure is described in detail below:

```
  Input: a data set D, a language model LM, a pre-defined distribution Ø, a number
of layers num_layers, and a number of heads num_heads;
  Output: a multi-head attention feature F;
  Initialization function list: F is an empty table;
  For each (Q, A)∈D do; //the following processing is performed for each pair (Q,
A) belonging to D:
  Sample Z~Ø; //sample Z that follows the distribution Ø;
  S=(Q, A), S1=(Q, A1), where A1=(a1, a2, ..., az), and A=(a1, a2, ..., aL);//S1 is
defined as (Q, A1), where A1 is a sub-sequence of A, includes the first z elements (a1, a2, ..., az),
and A includes all elements (a1, a2, ..., aL);
  For each layer 1 in range(num_layer)do; //for each layer 1 from 0 to num_layers−1,
perform:
  For each head h in range(num_heads)do; //for each head h from 0 to num_heads−
1, perform:
  Transformer (S1)=Xh; //Transformer (S1) to obtain Xh;
  Append Xh to F; //append Xh to the tail of F;
  End for;
  End for;
  End for;
  Return to F;
```

In some embodiments, after the training is completed, an orthogonal vector pointing to truthfulness is obtained in this embodiment of this disclosure. In this embodiment of this disclosure, the final orthogonal vector is calculated by using an exponential decay weight, and the heads are sorted, to obtain the final intervention vector:

$${Θ}_{l , h} = {\sum }_{k = 1}^{K} {w}_{k} {θ}_{l , h , k} , {w}_{k} = {e}^{- k} \qquad ( 11 )$$

wₖ is a weight factor, θ_{l,h,k} is a k^{th} orthogonal vector at a position (l, h).

When intervention is performed at the MHA layer, it is modified to a constant in this embodiment of this disclosure:

$${x}_{l + 1} = {x}_{l} + {\sum }_{h = 1}^{H} {Q}_{l}^{h} ( A t {t}_{l}^{h} ( {P}_{l}^{h} {x}_{l} ) + α {σ}_{l}^{h} {Θ}_{l , h}^{*} ) \qquad ( 12 )$$

x₁ and xₗ₊₁ represent an input and an output of an 1^{th} layer,

$${Q}_{l}^{h} , A t {t}_{l}^{h} , and {P}_{l}^{h}$$

are MHA components. H is a quantity of heads, and a is intervention strength. σₗ^{h} is a standard deviation that is computed by using another same distributed data set in this embodiment of this disclosure, to recover a directional modulus length before l2-norm standardization. Θ*_{l,h} is an effective intervention vector of a probe after Top-K screening for accuracy. Because an intervention item in each operation is a constant, time complexity of using TrFris O(1).

In some embodiments, a question-answer data set is obtained, and includes a question and a correct or incorrect answer corresponding to the question. In this embodiment of this disclosure, a feature is first extracted by using a to-be-intervened language model (such as LLaMA-7B). Next, in this embodiment of this disclosure, an appropriate sampling distribution is selected based on a hyperparameter, the input sequence is truncated at different positions by using a random peeping method, and features at each position in the language model are obtained after the input sequence is input into the model. Then, these features are configured for training probes that are orthogonal to each other at each position, to capture different aspects of representation of truthfulness in the model in this embodiment of this disclosure. After the training is completed, an orthogonal vector pointing to truthfulness is obtained in this embodiment of this disclosure. The final intervention vector is obtained after directions of a probe group are integrated. During task generation, that is, during actual inference, in this embodiment of this disclosure, an effective probe is selected for intervention (in this embodiment of this disclosure, the effective probe is obtained through a strategy such as a threshold or top-k screening). According to this embodiment of this disclosure, truthfulness of a generated result can be controlled by adjusting intervention strength. For example, in this embodiment of this disclosure, when it is intended to generate an answer that is related to a question and that is truthful and neutral, high intervention strength may be used. In this way, the generated answer can further avoid a hallucination result.

Therefore, in this embodiment of this disclosure, truthfulness of the generated result is improved through multi-directional intervention. The text processing method provided in this embodiment of this disclosure may include using orthogonal probes to represent truthfulness, using a random peeking method to alleviate a generation-discrimination difference, and implementing a truthfulness intervention process. By training the orthogonal probes, this embodiment of this disclosure can capture different aspects of representation of truthfulness in the model. The random peeking method makes the learned direction more stable and can be generalized to different positions in the generation process. In the generation task, this embodiment of this disclosure can control truthfulness of a generated result by adjusting intervention strength. In practical applications, this embodiment of this disclosure can be applied to various natural language processing tasks, such as text generation, a question-answering system, and a dialog system. In addition, this embodiment of this disclosure can also be used in combination with another generation model (such as another large model) to further improve truthfulness and reliability of the generated result.

In this embodiment of this disclosure, effectiveness of the method is tested in an open source dataset and an open source model, and is compared with a mainstream fact-enhanced solution. An experimental dataset, and a dataset that is strongly related to a hallucination problem are selected, and a variety of open source models are configured for an experiment. In this experiment, indicators in this embodiment of this disclosure may be: Determining indicator (True %): If a GPT model determines that an answer provided by a language model is not truthful, the indicator is 0, and if a GPT model determines that an answer provided by a language model is truthful, the indicator is 1. A mean is calculated in all question-answers. Detail-level indicator (True*Info %): Info % measures the level of detail in the language model's answer. Info % is generated in the same way and then multiplied by True %, to prevent high True % resulting from the language model continuously refusing to answer. Probability indicator (MC %): A probability of generating a Ground True answer for each TruthfulQA is calculated. If a correct answer is ranked first, the indicator is marked as 1; and if a correct answer is not ranked first, the indicator is marked as 0. Then, a mean of all samples is calculated. First intervention indicator (CE): Cross entry in pre-training data is calculated, represents a pre-training task loss of the language model, and is used as one of indicators for measuring the intervention strength. Second intervention indicator (KL): A distribution distance when each term is generated before and after intervention is calculated, and is used as one of indicators for measuring intervention strength.

In an example, Table 1 is an illustrative table (1) of experimental parameters according to an embodiment of this disclosure.

TABLE 1
Illustrative table (1) of experimental parameters
according to an embodiment of this disclosure

| | | | | |
|---|---|---|---|---|
| | | | First | Second |
| Determining | Detail-level | Probability | intervention | intervention |
| indicator | indicator | indicator | indicator | indicator |
| (True %) | (True*Info %) | (MC %) | (CE) | (KL) |

Related technology

| | | | | | |
|---|---|---|---|---|---|
| Baseline in the | 32.4 | 33.3 | 25.8 | 2.17 | — |
| related technology | | | | | |
| Supervised fine- | 36.1 | 47.1 | 24.2 | 2.10 | 0.01 |
| tuning | | | | | |
| Few-shot | 45.9 | 47.5 | 33.3 | 2.17 | — |
| prompting | | | | | |
| Related | 40.2 | 45.0 | 26.7 | 2.40 | 0.24 |
| technology | | | | | |
| Few-shot | 48.2 | 54.2 | 36.7 | 2.40 | 0.24 |
| prompting + related | | | | | |
| technology | | | | | |

This disclosure

| | | | | | |
|---|---|---|---|---|---|
| This disclosure | 41.5 | 45.8 | 27.5 | 2.26 | 0.10 |
| This | 57.5 | 62.5 | 26.7 | 2.26 | 0.10 |
| disclosure + few- | | | | | |
| shot prompting | | | | | |

In an example, Table 2 is an illustrative table (2) of experimental parameters according to an embodiment of this disclosure.

TABLE 2
Illustrative table (2) of experimental parameters
according to an embodiment of this disclosure

| | | | | |
|---|---|---|---|---|
| Determining | Detail-level | Probability | First | Second |
| indicator | indicator | indicator | intervention | intervention |
| (True %) | (True*Info %) | (MC %) | indicator (CE) | indicator (KL) |

Related technology

| | | | | | |
|---|---|---|---|---|---|
| Baseline in | 29.6 | 30.6 | 25.8 | 2.15 | — |
| the related | | | | | |
| technology | | | | | |
| Random | 30.5 | 31.6 | 24.2 | 2.21 | 0.02 |
| direction | | | | | |
| CCS | 33.4 | 34.7 | 26.2 | 2.21 | — |
| ITI probe | 34.1 | 35.4 | 26.8 | 2.20 | 0.06 |
| weight | | | | | |
| direction | | | | | |
| ITI mean | 42.1 | 45.4 | 29.0 | 2.41 | 0.28 |
| offset | | | | | |

This disclosure

| | | | | | |
|---|---|---|---|---|---|
| Orthogonal | 50.2 | 55.0 | 28.8 | 2.18 | 0.05 |
| direction in | | | | | |
| this | | | | | |
| disclosure | | | | | |
| Single | 63.2 | 77.2 | 31.3 | 2.48 | 0.36 |
| dimension | | | | | |
| in this | | | | | |
| disclosure | | | | | |

In some embodiments, the baseline is an LLaMA-7B model before intervention. The random direction is a randomly normally distributed sample used as a direction, and TOP-K positions are randomly selected for intervention. This functions as a control group. ITI is two methods for improving truthfulness of a language model, and is used as a baseline. Supervised fine-tuning is a downstream fine tuning solution in a language model. Few-shot prompting is a context learning manner. In this embodiment of this disclosure, 80 correct question-answer pairs are extracted from TruthfulQA as prompting learning.

In some embodiments, to be in a fair comparison with few-shot prompting, only 80 samples are used in all manners of few-shot setting. In full data settings, in this embodiment of this disclosure, a complete dataset of TruthfulQA is configured for cross validation in a double fold manner, and each fold has a ratio: train:valid:test=4:1:5.

An experimental result shows that the text processing method provided in this embodiment of this disclosure achieves significant performance improvement in a plurality of scenarios. In terms of a complete dataset, this embodiment of this disclosure has better performance compared with an implementation in a related technology. An experimental result indicates that in this embodiment of this disclosure, performance can be significantly increased by True*Info % at any stage with minimum intervention. This embodiment of this disclosure is compared with the related technology. In a setting of few samples, this embodiment of this disclosure achieves a better result when FSP is compatible. CE and KL results indicate that in this embodiment of this disclosure, when an amount of information is kept, better performance is achieved with minimum intervention.

TABLE 3
Illustrative table (3) of experimental parameters
according to an embodiment of this disclosure

| | | | | |
|---|---|---|---|---|
| Determining | Detail-level | Probability | First | Second |
| indicator | indicator | indicator | intervention | intervention |
| (True %) | (True*Info %) | (MC %) | indicator (CE) | indicator (KL) |

Pre-trained model

| | | | | | |
|---|---|---|---|---|---|
| Pre-trained | 29.6 | 30.6 | 25.6 | 2.15 | — |
| model A | | | | | |
| Pre-trained | 50.2 | 55.0 | 28.8 | 2.18 | 0.05 |
| model | | | | | |
| A + this | | | | | |
| disclosure | | | | | |
| Pre-trained | 37.5 | 40.8 | 26.2 | 2.07 | — |
| model B | | | | | |
| Pre-trained | 56.0 | 74.5 | 33.8 | 2.19 | 0.08 |
| model | | | | | |
| B + this | | | | | |
| disclosure | | | | | |

Fine-tuned model

| | | | | | |
|---|---|---|---|---|---|
| Fine-tuned | 40.7 | 40.8 | 26.2 | 2.51 | — |
| model A | | | | | |
| Fine-tuned | 70.5 | 77.6 | 30.8 | 2.74 | 0.50 |
| model | | | | | |
| A + this | | | | | |
| disclosure | | | | | |
| Fine-tuned | 55.4 | 59.1 | 33.3 | 2.59 | — |
| model B | | | | | |
| Fine-tuned | 78.8 | 88.8 | 38.8 | 2.76 | 0.54 |
| model | | | | | |
| B + this | | | | | |
| disclosure | | | | | |

In this embodiment of this disclosure, experiments are performed on both a pre-trained model before a related model is fine-tuned and a fine-tuned model. After the text processing method provided in this embodiment of this disclosure is introduced, performance of the models at different stages is significantly improved.

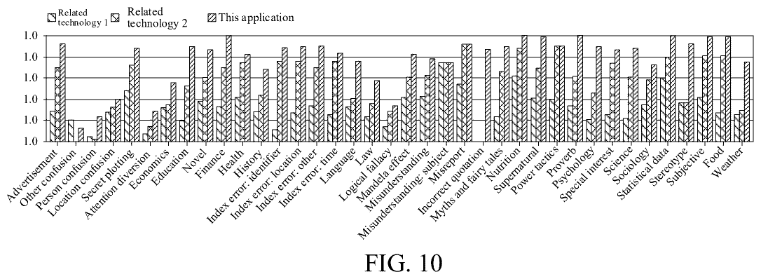

In some embodiments, FIG. 10 is a schematic diagram of experimental effect of a text processing method according to an embodiment of this disclosure. Performance of a text generation model in this disclosure and a related technology is compared in data sets of different types (for example, an education topic data set, a financial topic data set, and a fine-tuning data set). It can be learned from FIG. 10 that the performance of the text generation model can be improved in data sets of almost all types.

In this way, in this embodiment of this disclosure, truthfulness of a generated result is improved through multi-directional intervention, and a problem that a pre-trained language model generates untruthful information in a generation task can be effectively resolved. This embodiment of this disclosure can effectively relieve a generation-distinction difference, so that a learned direction is more stable, and can be generalized to different positions in a generation process. This embodiment of this disclosure has low time complexity, and is easy to implement and apply. This embodiment of this disclosure may be applied to various natural language processing tasks, and has wide applicability. This embodiment of this disclosure may be used in combination with another generation model, to further improve truthfulness and reliability of a generated result. By adjusting the intervention strength, a user can control truthfulness of the generated result as required, thereby improving quality of the generated result.

In this way, feature encoding is performed on the to-be-processed text, to obtain the initial text feature of the to-be-processed text. Truthfulness prediction is performed on the logic of the to-be-processed text in the at least one prediction dimension based on the initial text feature, to obtain the truthfulness prediction result of the to-be-processed text in each prediction dimension. When the truthfulness prediction result indicates that the to-be-processed text is not truthful in a corresponding prediction dimension, a correction feature in the corresponding prediction dimension is obtained. Feature correction is performed on the initial text feature based on the correction feature, to obtain the target text feature corresponding to the initial text feature. Feature decoding is performed on the target text feature, to obtain the target text being truthful in each prediction dimension. In this way, truthfulness prediction is performed on the logic of the to-be-processed text in at least one prediction dimension based on the initial text feature, to obtain the truthfulness prediction result of the to-be-processed text in each prediction dimension. Feature correction is performed on the initial text feature, to obtain the target text feature, and feature decoding is performed on the target text feature, so that the target text is truthful in each prediction dimension, thereby effectively improving accuracy of the target text, and effectively improving accuracy of text processing.

The following continues to describe a structure of the text processing apparatus 455 implemented as a software module provided in this embodiment of this disclosure. In some embodiments, as shown in FIG. 2, the software module in the text processing apparatus 455 stored in the memory 450 may include: the feature encoding module 4551, configured to perform feature encoding on a to-be-processed text, to obtain an initial text feature of the to-be-processed text; a truthfulness prediction module 4552, configured to perform truthfulness prediction on logic of the to-be-processed text in at least one prediction dimension based on the initial text feature, to obtain a truthfulness prediction result of the to-be-processed text in each prediction dimension; an obtaining module 4553, configured to: for each prediction dimension, when the truthfulness prediction result in the prediction dimension indicates that the to-be-processed text is not truthful in the prediction dimension, obtain a correction feature of the initial text feature in the prediction dimension; a feature correction module 4554, configured to perform feature correction on the initial text feature based on the correction feature, to obtain a target text feature corresponding to the initial text feature; and a feature decoding module 4555, configured to perform feature decoding on the target text feature, to obtain a target text corresponding to the to-be-processed text, the target text being truthful in each prediction dimension.

In some embodiments, the feature encoding is implemented by using at least one feature encoding network. The feature encoding module is further configured to invoke a first feature encoding network, to perform feature encoding on the to-be-processed text, to obtain a first initial text feature; and iterate over i to perform the following processing: invoking an i^{th} feature encoding network, and performing feature encoding on the to-be-processed text based on an (i−1)^{th} initial text feature, to obtain an i^{th} initial text feature, where 1<i≤N, and N indicates a quantity of feature encoding networks; and determining an N^{th} initial text feature as the initial text feature of the to-be-processed text.

In some embodiments, the text processing apparatus further includes: a feature check module, configured to: perform truthfulness prediction on the logic of the to-be-processed text in each prediction dimension based on the (i−1)^{th} initial text feature, to obtain an (i−1)^{th} truthfulness prediction result of the to-be-processed text in each prediction dimension; and perform feature check on the (i−1)^{th} initial text feature based on the (i−1)^{th} truthfulness prediction result, to obtain an (i−1)^{th} target text feature. The feature encoding module is further configured to: invoke an i^{th} feature encoding network, and perform feature encoding on the to-be-processed text based on the (i−1)^{th} target text feature, to obtain the i^{th} initial text feature.

In some embodiments, the feature check module is further configured to: when the (i−1)^{th} truthfulness prediction result indicates that the to-be-processed text is not truthful in the corresponding prediction dimension, perform feature correction on the (i−1)^{th} initial text feature, to obtain the (i−1)^{th} target text feature; and when each (i−1)^{th} truthfulness prediction result indicates that the to-be-processed text is truthful in the corresponding prediction dimension, determine the (i−1)^{th} initial text feature as the (i−1)^{th} target text feature.

In some embodiments, the truthfulness prediction module is further configured to: obtain a truthfulness prediction network corresponding to each prediction dimension, and perform the following processing for each prediction dimension: invoking the corresponding truthfulness prediction network, and performing truthfulness prediction on the logic of the to-be-processed text in the prediction dimension based on the initial text feature, to obtain a truthfulness score of the to-be-processed text in the prediction dimension; when the truthfulness score is greater than or equal to a score threshold, determine a truthfulness prediction result in the prediction dimension as a first result, the first result indicating that the to-be-processed text is truthful in the prediction dimension; and when the truthfulness score is less than the score threshold, determine a truthfulness prediction result in the prediction dimension as a second result, the second result indicating that the to-be-processed text is not truthful in the prediction dimension.

In some embodiments, the truthfulness prediction module is further configured to: obtain an initial prediction network, and obtain a plurality of text feature samples corresponding to a text sample and a truthfulness label score of each text feature sample; for each text feature sample, invoke the initial prediction network, and perform truthfulness prediction on logic of the text sample of the prediction dimension based on the text feature sample, to obtain a truthfulness score corresponding to the text feature sample, and determine a loss value corresponding to the text feature sample with reference to the truthfulness score and the corresponding truthfulness label score; and train the initial prediction network based on the loss value corresponding to each text feature sample, to obtain the truthfulness prediction network corresponding to the prediction dimension.

In some embodiments, the truthfulness prediction module is further configured to: obtain the text sample, and perform feature encoding on the text sample, to obtain an initial text feature of the text sample; and perform feature splitting on the initial text feature of the text sample, to obtain a plurality of text feature samples corresponding to the text sample.

In some embodiments, the truthfulness prediction module is further configured to: obtain the text sample, and perform feature encoding on the text sample, to obtain an initial text feature of the text sample; and perform feature splitting on the initial text feature of the text sample, to obtain a plurality of text feature samples corresponding to the text sample.

In some embodiments, the truthfulness prediction module is further configured to: obtain an initial prediction network, and obtain a first text feature sample corresponding to a text sample of a first prediction dimension, and a first truthfulness label score of the first text feature sample; invoke the initial prediction network, perform truthfulness prediction on logic of the text sample of the first prediction dimension based on the first text feature sample, to obtain a first truthfulness score, and train the initial prediction network with reference to the first truthfulness score and the first truthfulness label score, to obtain a truthfulness prediction network corresponding to the first prediction dimension; and iterate over j to perform the following processing: obtaining a (j−1)^{th} truthfulness score corresponding to a text sample of a (j−1)^{th} prediction dimension, and training the initial prediction network based on the (j−1)^{th} truthfulness score, to obtain a truthfulness prediction network corresponding to a j^{th} prediction dimension. 2≤j≤M, and M indicates a quantity of prediction dimensions.

In one example, when the one or more prediction dimensions correspond to M prediction dimensions, M being a positive integer greater than 1, the obtaining the truthfulness prediction network corresponding to each prediction dimension includes obtaining an initial prediction network and obtaining a first text feature sample corresponding to a text sample of a first prediction dimension, and a first truthfulness label score of the first text feature sample. In one example, the obtaining the truthfulness prediction network corresponding to each prediction dimension includes obtaining a first truthfulness score based on the initial prediction network being applied to the first text feature sample and obtaining a truthfulness prediction network corresponding to the first prediction dimension based on the initial prediction network being trained with reference to the first truthfulness score and the first truthfulness label score. In one example, the obtaining the truthfulness prediction network corresponding to each prediction dimension includes obtaining a (j−1)^{th} truthfulness score corresponding to a text sample of the (j-1)^{th} prediction dimension and obtaining a truthfulness prediction network corresponding to a j^{th} prediction dimension based on the initial prediction network being trained with reference to the (j−1)^{th} truthfulness score. In one example, j is a positive integer ranging from 2 to M.

In some embodiments, the truthfulness prediction module is further configured to obtain a j^{th} text feature sample corresponding to a text sample of the j^{th} prediction dimension, and a j^{th} truthfulness label score of the j^{th} text feature sample; invoke the initial prediction network, and perform truthfulness prediction on logic of the text sample of the j^{th} prediction dimension based on the j^{th} text feature sample, to obtain a j^{th} truthfulness score; determine a first loss value with reference to the j^{th} truthfulness score and the (j−1)^{th} truthfulness score, and determine a second loss value with reference to the j^{th} truthfulness score and the j^{th} truthfulness label score; and train the initial prediction network with reference to the first loss value and the second loss value, to obtain the truthfulness prediction network corresponding to the j^{th} prediction dimension.

In some embodiments, the feature decoding module is further configured to: when the truthfulness prediction result in each prediction dimension indicates that the to-be-processed text is not truthful in the corresponding prediction dimension, perform feature decoding on the initial text feature, to obtain the target text corresponding to the to-be-processed text.

In some embodiments, the correction features are in one-to-one correspondence with target prediction dimensions, and the to-be-processed text is not truthful in the target prediction dimensions. The feature correction module is further configured to: obtain a truthfulness score of the to-be-processed text in each target prediction dimension, and determine each truthfulness score as a weight of the corresponding correction feature; perform weighted fusion on the correction features based on the weights of the correction features, to obtain the reference correction feature; and perform feature correction on the initial text feature based on the reference correction feature, to obtain the target text feature corresponding to the initial text feature.

In some embodiments, the feature correction module is further configured to: obtain a feature dimension of the initial text feature and a feature dimension of the reference correction feature; when the feature dimension of the initial text feature is different from the feature dimension of the reference correction feature, adjust the feature dimension of the reference correction feature, to obtain a target correction feature; when the feature dimension of the initial text feature is the same as the feature dimension of the reference correction feature, determine the reference correction feature as the target correction feature; determine correction strength of the initial text feature based on a quantity of correction features, the correction strength being positively correlated to the quantity of correction features; and determine a product of the correction strength and the target correction feature as a fusion feature, and add the initial text feature and the fusion feature, to obtain the target text feature.

In some embodiments, the feature decoding module is further configured to: obtain a task type of the to-be-processed text, and obtain a task prediction network corresponding to the task type; when the task type is an answer prediction task configured for answering for the to-be-processed text, invoke a task prediction network corresponding to the answer prediction task, and perform answer prediction on the to-be-processed text based on the target text feature, to obtain an answer text corresponding to the to-be-processed text, the answer text being truthful in each prediction dimension; and when the task type is a translation task configured for translating the to-be-processed text, invoke a task prediction network corresponding to the translation task, and translate the to-be-processed text based on the target text feature, to obtain a translated text corresponding to the to-be-processed text, the translated text being truthful in each prediction dimension.

In some embodiments, the feature encoding module is further configured to: obtain a truthfulness prediction network corresponding to each prediction dimension, and perform the following processing for each prediction dimension: invoking the corresponding truthfulness prediction network, and performing truthfulness prediction on the logic of the to-be-processed text in the prediction dimension based on the (i−1)^{th} initial text feature, to obtain an (i−1)^{th} truthfulness score of the to-be-processed text in the prediction dimension; when the (i−1)^{th} truthfulness score is greater than or equal to a score threshold, determining the (i−1)^{th} truthfulness prediction result in the prediction dimension as: the to-be-processed text is truthful in the prediction dimension; and when the (i−1)^{th} truthfulness score is less than the score threshold, determining the (i−1)^{th} truthfulness prediction result in the prediction dimension as: the to-be-processed text is not truthful in the prediction dimension.

In some embodiments, the feature encoding module is further configured to: obtain an initial prediction network, and obtain a first text feature sample corresponding to a text sample of a first prediction dimension, and a first truthfulness label score of the first text feature sample; invoke the initial prediction network, perform truthfulness prediction on logic of the text sample of the first prediction dimension based on the first text feature sample, to obtain a first truthfulness score, and train the initial prediction network with reference to the first truthfulness score and the first truthfulness label score, to obtain a truthfulness prediction network corresponding to the first prediction dimension; and iterate over j to perform the following processing: obtaining a (j−1)^{th} truthfulness score corresponding to a text sample of a (j−1)^{th} prediction dimension, and training the initial prediction network based on the (j−1)^{th} truthfulness score, to obtain a truthfulness prediction network corresponding to a j^{th} prediction dimension. 2≤j≤M, and M indicates a quantity of prediction dimensions.

In some embodiments, the truthfulness prediction module is further configured to perform the following processing for each feature character in the initial text feature: determining the feature character as a target feature character, and combining the target feature character with another feature character in the initial text feature in various manners, to obtain the at least one text feature sample corresponding to the target feature character.

In some embodiments, the obtaining module is further configured to: obtain a dimension-feature mapping relationship; determine the prediction dimension as a target prediction dimension, and query the dimension-feature mapping relationship for a target index entry including the target prediction dimension; and determine a feature in the target index entry as a correction feature of the initial text feature in the target prediction dimension.

An embodiment of this disclosure provides a computer program product, the computer program product including a computer program or computer-executable instructions, and the computer program or the computer-executable instructions being stored in a computer-readable storage medium, such as a non-transitory computer-readable storage medium. A processor of an electronic device reads the computer-executable instructions from the non-transitory computer-readable storage medium, and the processor executes the non-transitory computer-executable instructions, so that the electronic device executes the foregoing text processing method in embodiments of this disclosure.

An embodiment of this disclosure provides a non-transitory computer-readable storage medium storing computer-executable instructions, the computer-executable instructions, when executed by a processor, causing the processor to perform the text processing method provided in embodiments of this disclosure, for example, the text processing method shown in FIG. 3.

In some embodiments, the non-transitory computer-readable storage medium may be a memory such as a ferroelectric random access memory (FRAM), a read-only memory (ROM), a programmable read-only memory (PROM), an electrically programmable read-only memory (EPROM), an electrically erasable programmable read-only memory (EEPROM), a flash memory, a magnetic surface memory, an optical disc, or a compact disc read-only memory (CD-ROM), or may be various devices including one of the foregoing memories or any combination thereof.

In some embodiments, the computer-executable instruction may be written in the form of program, software, software module, script, or code in any form of programming language (including compilation or interpretation language, or declarative or procedural language), and may be deployed in any form, including being deployed as an independent program or being deployed as a module, component, subroutine, or another unit suitable for use in a computing environment.

For example, the computer-executable instructions may, but do not necessarily, correspond to a file in a file system, and may be stored in a part of a file that saves another program or other data, for example, be stored in one or more scripts in a hypertext markup language (HTML) file, stored in a file that is specially configured for a program in discussion, or stored in a plurality of collaborative files (for example, be stored in files of one or more modules, subprograms, or code parts).

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (for example, computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

In an example, the computer-executable instruction may be deployed to be executed on one electronic device, on a plurality of electronic devices located at one location, or on a plurality of electronic devices distributed at a plurality of locations and interconnected through a communication network.

In summary, embodiments of this disclosure have the following beneficial effects:

(1) Feature encoding is performed on the to-be-processed text, to obtain the initial text feature of the to-be-processed text. Truthfulness prediction is performed on the logic of the to-be-processed text in the at least one prediction dimension based on the initial text feature, to obtain the truthfulness prediction result of the to-be-processed text in each prediction dimension. When the truthfulness prediction result indicates that the to-be-processed text is not truthful in a corresponding prediction dimension, a correction feature in the corresponding prediction dimension is obtained. Feature correction is performed on the initial text feature based on the correction feature, to obtain the target text feature corresponding to the initial text feature. Feature decoding is performed on the target text feature, to obtain the target text being truthful in each prediction dimension. In this way, truthfulness prediction is performed on the logic of the to-be-processed text in at least one prediction dimension based on the initial text feature, to obtain the truthfulness prediction result of the to-be-processed text in each prediction dimension. Feature correction is performed on the initial text feature, to obtain the target text feature, and feature decoding is performed on the target text feature, so that the target text is truthful in each prediction dimension, thereby effectively improving accuracy of the target text, and effectively improving accuracy of text processing.

(2) Before the i^{th} feature encoding network is invoked, feature check is performed on the (i−1)^{th} initial text feature, to obtain the (i−1)^{th} target text feature. Then, the i^{th} feature encoding network is invoked, and feature encoding is performed on the to-be-processed text based on the (i−1)^{th} target text feature, to obtain the i^{th} initial text feature, so that feature check is performed on a plurality of feature encoding networks layer by layer, to enhance the performance of an input of each layer of feature encoding network corresponding to a target text feature obtained after strict feature check is performed. Therefore, the feature encoding networks can gradually optimize feature encoding of the to-be-processed text, to more effectively improve accuracy of feature encoding.

(3) Feature encoding is performed on the text sample, to obtain the initial text feature of the text sample, and feature splitting is performed on the initial text feature of the text sample, to obtain the plurality of text feature samples corresponding to the text sample, thereby effectively expanding a quantity of training samples of the initial prediction network, and effectively improving prediction performance of a truthfulness prediction network obtained through training.

(4) The (j−1)^{th} truthfulness score corresponding to the text sample of the (j−1)^{th} prediction dimension is obtained, and the initial prediction network is trained based on the (j−1)^{th} truthfulness score, to obtain the truthfulness prediction network corresponding to the j^{th} prediction dimension, so that the truthfulness prediction network corresponding to the j^{th} prediction dimension can make effective use of a network parameter of a truthfulness prediction network corresponding to the (j−1)^{th} prediction dimension, and a prediction direction of the truthfulness prediction network corresponding to the j^{th} prediction dimension keeps being orthogonal to a prediction direction of the truthfulness prediction network corresponding to the (j−1)^{th} prediction dimension, thereby effectively improving prediction independence between truthfulness prediction networks in different prediction dimensions.

(5) A corresponding feature dimension of the initial text feature is corrected, so that a text obtained by performing feature decoding on the corrected initial text feature can be truthful in the corresponding feature dimension, to more effectively improve accuracy of the generated target text.

(6) In embodiments of this disclosure, truthfulness of a generated result is improved through multi-directional intervention, and a problem that a pre-trained language model generates untruthful information in a generation task can be effectively resolved. Embodiments of this disclosure can effectively relieve a generation-distinction difference, so that a learned direction is more stable, and can be generalized to different positions in a generation process. Embodiments of this disclosure have low time complexity, and are easy to implement and apply. Embodiments of this disclosure may be applied to various natural language processing tasks, and have wide applicability. Embodiments of this disclosure may be used in combination with another generation model, to further improve truthfulness and reliability of a generated result. By adjusting the intervention strength, a user can control truthfulness of the generated result as required, thereby improving quality of the generated result.

(7) In embodiments of this disclosure, experiments are performed on both a pre-trained model before a related model is fine-tuned and a fine-tuned model. After the text processing method provided in embodiments of this disclosure is introduced, performance of the models at different stages is significantly improved.

(8) An experimental result shows that the text processing method provided in embodiments of this disclosure achieves significant performance improvement in a plurality of scenarios. In terms of a complete dataset, embodiments of this disclosure have better performance compared with an implementation in a related technology. An experimental result indicates that in embodiments of this disclosure, performance can be significantly increased by True*Info % at any stage with minimum intervention. Embodiments of this disclosure are compared with the related technology. In a setting of few samples, embodiments of this disclosure achieve a better result when FSP is compatible. CE and KL results indicate that in embodiments of this disclosure, when an amount of information is kept, better performance is achieved with minimum intervention.

(9) Customized evaluation can be provided for each prediction dimension, to significantly improve overall accuracy and reliability of text truthfulness detection. The dedicated network is allocated to each prediction dimension, so that information specific to the dimension can be better captured and processed, so that truthfulness prediction is more accurate. Performing truthfulness scoring based on the (i−1)^{th} initial text feature not only fully uses valuable information extracted in a previous iteration, but also provides a clear decision criterion for each dimension through application of the score threshold. This not only makes a prediction result more interpretable, but also provides finer guidance for subsequent decision or processing through distinguishing between the first result and the second result.

(10) The initial prediction network is configured for truthfulness evaluation on the to-be-processed text feature sample. By continuously performing iterative prediction and calculating the loss value, the network can gradually learn and capture a complex relationship between text features and truthfulness. This training method enables the prediction network to be specially optimized for different prediction dimensions, thereby significantly improving performance of the prediction network on a truthfulness detection task. Finally, a fully trained prediction network can predict truthfulness of a text more accurately, and provide a powerful tool for scenarios such as a social media platform and a news aggregator to identify and filter untruthful information, thereby enhancing credibility of information propagation and user security.

(11) When a truthfulness prediction result indicates that the to-be-processed text may not be truthful in a particular prediction dimension, feature correction can beneficially improve accuracy of text truthfulness detection. Targeted adjustment is performed on the (i−1)^{th} initial text feature, to obtain the (i−1)^{th} target text feature, so that feature impact inconsistent with a prediction result can be effectively removed or alleviated, and subsequent feature encoding and network training can focus more on truthful text information. When it indicates that the to-be-processed text is truthful in all the prediction dimensions, the (i−1)^{th} initial text feature is kept unchanged, to help keep important information of the text and avoid unnecessary feature distortion. Such a dynamic feature processing method not only improves robustness of a model, but also optimizes an ability of the model to recognize a truthful text, and finally significantly improves performance and reliability of truthfulness detection.

(12) A weight of a feature is dynamically adjusted by evaluation on text truthfulness according to each prediction dimension, to reduce or exclude possible untruthful or misleading information while keeping key information. Weighted fusion is performed on the correction features to obtain the reference correction feature, so that text truthfulness can be reflected more accurately, to accurately correct the initial text feature based on the reference correction feature. Finally, the obtained target text feature not only better represents text truthfulness, but also improves subsequent performance and reliability of a truthfulness prediction model, and can be more effective and robust when complex and diversified text data is processed.

The foregoing descriptions are only some embodiments of this disclosure and are not intended to limit the scope of this disclosure. Any modification, equivalent replacement, improvement, and the like made within the spirit and scope of this disclosure shall fall within the protection scope of this disclosure.

What is claimed is:

1. A text processing method, comprising:
obtaining an initial text feature of a to-be-processed text based on feature encoding of the to-be-processed text;
obtaining one or more truthfulness prediction results of the to-be-processed text in one or more prediction dimensions, the one or more truthfulness prediction results corresponding to one or more truthfulness predictions of logic of the to-be-processed text in the one or more prediction dimensions based on the initial text feature;
for each of the one or more prediction dimensions, obtaining a correction feature of the initial text feature in the respective prediction dimension when the corresponding truthfulness prediction result in the respective prediction dimension indicates that the to-be-processed text is not truthful in the respective prediction dimension;
obtaining a target text feature corresponding to the initial text feature based on the correction feature for each of the one or more prediction dimensions; and
obtaining, by processing circuitry, a target text corresponding to the to-be-processed text based on feature decoding of the target text feature.

2. The method according to claim 1, wherein
the feature encoding is based on at least one feature encoding network, and
when the at least one feature encoding network corresponds to N feature encoding networks, N being an integer greater than 1, the obtaining the initial text feature of the to-be-processed text includes:
obtaining a first initial text feature based on a first feature encoding network of the N feature encoding networks being applied to the to-be-processed text;
obtaining an i^{th} initial text feature based on an i^{th} feature encoding network of the N feature encoding networks being applied to the to-be-processed text based on an (i−1)^{th} initial text feature, i ranging from 2 to N; and
determining the N^{th} initial text feature as the initial text feature of the to-be-processed text.

3. The method according to claim 2, wherein
the obtaining the i^{th} initial text feature further includes:
obtaining an (i−1)^{th} truthfulness prediction result of the to-be-processed text corresponding to truthfulness prediction of the logic of the to-be-processed text in each prediction dimension based on the (i−1)^{th} initial text feature; and
obtaining an (i−1)^{th} target text feature based on a feature check of the (i−1)^{th} initial text feature and the (i−1)^{th} truthfulness prediction result, and
the obtaining the i^{th} initial text feature includes:
applying the i^{th} feature encoding network to the to-be-processed text based on the (i−1)^{th} target text feature.

4. The method according to claim 3, wherein the obtaining the (i−1)^{th} target text feature comprises:
when the (i−1)^{th} truthfulness prediction result indicates that the to-be-processed text is not truthful in the corresponding prediction dimension, performing feature correction on the (i−1)^{th} initial text feature; and
when each (i−1)^{th} truthfulness prediction result indicates that the to-be-processed text is truthful in the corresponding prediction dimension, determining the (i−1)^{th} initial text feature as the (i−1)^{th} target text feature.

5. The method according to claim 3, wherein the obtaining the (i−1)^{th} truthfulness prediction result in each prediction dimension comprises:
obtaining a truthfulness prediction network corresponding to each prediction dimension; and
for each prediction dimension, performing operations including:
obtaining an (i−1)^{th} truthfulness score of the to-be-processed text in the respective prediction dimension based on the corresponding truthfulness prediction network being applied to the (i−1)^{th} initial text feature;
when the (i−1)^{th} truthfulness score is greater than or equal to a score threshold, determining a corresponding truthfulness prediction result in the respective prediction dimension as indicating that the to-be-processed text is truthful in the respective prediction dimension; and
when the (i−1)^{th} truthfulness score is less than the score threshold, determining the corresponding truthfulness prediction result in the respective prediction dimension as indicating that the to-be-processed text is not truthful in the respective prediction dimension.

6. The method according to claim 5, wherein when the one or more prediction dimensions correspond to M prediction dimensions, M being a positive integer greater than 1, the obtaining the truthfulness prediction network corresponding to each prediction dimension comprises:
obtaining an initial prediction network;
obtaining a first text feature sample corresponding to a text sample of a first prediction dimension, and a first truthfulness label score of the first text feature sample;
obtaining a first truthfulness score based on the initial prediction network being applied to the first text feature sample;
obtaining a truthfulness prediction network corresponding to the first prediction dimension based on the initial prediction network being trained with reference to the first truthfulness score and the first truthfulness label score;
obtaining a (j−1)^{th} truthfulness score corresponding to a text sample of a (j−1)^{th} prediction dimension; and
obtaining a truthfulness prediction network corresponding to a j^{th} prediction dimension based on the initial prediction network being trained with reference to the (j−1)^{th} truthfulness score,
j being a positive integer ranging from 2 to M.

7. The method according to claim 1, wherein the obtaining the respective truthfulness prediction results of the to-be-processed text comprises:
obtaining a truthfulness prediction network corresponding to each prediction dimension; and
for each prediction dimension:
obtaining a truthfulness score of the to-be-processed text in the respective prediction dimension based on the corresponding truthfulness prediction network being applied to the initial text feature;
when the truthfulness score is greater than or equal to a score threshold, determining a truthfulness prediction result as a first result indicating that the to-be-processed text is truthful in the respective prediction dimension; and
when the truthfulness score is less than the score threshold, determining the truthfulness prediction result as a second result indicating that the to-be-processed text is not truthful in the respective prediction dimension.

8. The method according to claim 7, wherein, when the one or more prediction dimensions corresponds to one prediction dimension, the obtaining the truthfulness prediction network corresponding to each prediction dimension comprises:
obtaining an initial prediction network, a plurality of text feature samples corresponding to a text sample, and a truthfulness label score of each text feature sample;
for each text feature sample,
obtaining a truthfulness score based on the initial prediction network being applied to the respective text feature sample, and
determining a loss value corresponding to the respective text feature sample with reference to the truthfulness score and the corresponding truthfulness label score of the respective text feature sample; and
obtaining the truthfulness prediction network corresponding to the respective prediction dimension based on the initial prediction network being trained with reference to the loss value corresponding to each text feature sample.

9. The method according to claim 8, wherein the obtaining the plurality of text feature samples comprises:
obtaining the text sample;
obtaining an initial text feature of the text sample based on feature encoding of the text sample; and
obtaining the plurality of text feature samples corresponding to the text sample based on feature splitting of the initial text feature of the text sample.

10. The method according to claim 9, wherein the obtaining the plurality of text feature samples corresponding to the text sample comprises, for each feature character in the initial text feature:
determining the corresponding feature character as a target feature character; and
obtaining one or more text feature samples corresponding to the target feature character based on one or more combinations of the target feature character with another feature character in the initial text feature.

11. The method according to claim 7, wherein, when the one or more prediction dimensions correspond to M prediction dimensions, M being a positive integer greater than 1, the obtaining the truthfulness prediction network corresponding to each prediction dimension comprises:
obtaining an initial prediction network;
obtaining a first text feature sample corresponding to a text sample of a first prediction dimension, and a first truthfulness label score of the first text feature sample;
obtaining a first truthfulness score based on the initial prediction network being applied to the first text feature sample;
obtaining a truthfulness prediction network corresponding to the first prediction dimension based on the initial prediction network being trained with reference to the first truthfulness score and the first truthfulness label score;
obtaining a (j−1)^{th} truthfulness score corresponding to a text sample of the (j−1)^{th} prediction dimension; and
obtaining a truthfulness prediction network corresponding to a j^{th} prediction dimension based on the initial prediction network being trained with reference to the (j−1)^{th} truthfulness score,
j being a positive integer ranging from 2 to M.

12. The method according to claim 11, wherein the obtaining the truthfulness prediction network corresponding to the j^{th} prediction dimension comprises:
obtaining a j^{th} text feature sample corresponding to a text sample of the j^{th} prediction dimension and a j^{th} truthfulness label score of the j^{th} text feature sample;
obtaining a j^{th} truthfulness score based on the initial prediction network being applied to the j^{th} text feature sample;
determining a first loss value with reference to the j^{th} truthfulness score and the (j−1)^{th} truthfulness score;
determining a second loss value with reference to the j^{th} truthfulness score and the j^{th} truthfulness label score; and
obtaining the truthfulness prediction network corresponding to the j^{th} prediction dimension based on the initial prediction network being trained with reference to the first loss value and the second loss value.

13. The method according to claim 1, wherein the obtaining the target text corresponding to the to-be-processed text comprises:
when the truthfulness prediction result in each prediction dimension indicates that the to-be-processed text is truthful in the corresponding prediction dimension, determining the initial text feature as the target text feature.

14. The method according to claim 1, wherein
one or more correction features are in one-to-one correspondence with one or more target prediction dimensions, based on the to-be-processed text being not truthful in the one or more target prediction dimensions, and
the obtaining the target text corresponding to the to-be-processed text based on the feature correction of the initial text feature includes:
obtaining a truthfulness score of the to-be-processed text in each target prediction dimension;
determining each truthfulness score as a weight of the corresponding correction feature;
obtaining a reference correction feature based on weighted fusion of the one or more correction features and the weights of the one or more correction features; and
obtaining the target text based on the initial text feature and the reference correction feature.

15. The method according to claim 14, wherein the obtaining the target text based on the initial text feature and the reference correction feature comprises:
obtaining a feature dimension of the initial text feature and a feature dimension of the reference correction feature;
when the feature dimension of the initial text feature is different from the feature dimension of the reference correction feature, obtaining a target correction feature based on adjustment of the feature dimension of the reference correction feature;
when the feature dimension of the initial text feature is the same as the feature dimension of the reference correction feature, determining the reference correction feature as the target correction feature;
determining correction strength of the initial text feature based on a quantity of correction features, the correction strength being positively correlated to the quantity of correction features; and
obtaining the target text feature based on adding the initial text feature and a fusion feature, the fusion feature corresponding to a product of the correction strength and the target correction features.

16. The method according to claim 1, wherein the obtaining the target text corresponding to the to-be-processed text based on the feature decoding of the target text feature comprises:
obtaining a task type of the to-be-processed text;
obtaining a task prediction network corresponding to the task type;
when the task type corresponds to an answer prediction task indicating answering the to-be-processed text, obtaining an answer text corresponding to the to-be-processed text based on the task prediction network being applied to the target text feature, the answer text being truthful in each prediction dimension; and
when the task type corresponds to a translation task indicating translating the to-be-processed text, obtaining a translated text corresponding to the to-be-processed text based on the task prediction network being applied to the target text feature, the translated text being truthful in each prediction dimension.

17. The method according to claim 1, wherein the obtaining the correction feature of the initial text feature in the corresponding prediction dimension comprises:
obtaining a dimension-feature mapping relationship;
determining the corresponding prediction dimension as a target prediction dimension;
querying the dimension-feature mapping relationship for a target index entry including the target prediction dimension; and
determining a feature in the target index entry as a correction feature of the initial text feature in the target prediction dimension.

18. A text processing apparatus, comprising:
processing circuitry configured to:
obtain an initial text feature of a to-be-processed text based on feature encoding of the to-be-processed text;
obtain one or more truthfulness prediction results of the to-be-processed text in one or more prediction dimensions, the one or more truthfulness prediction results corresponding to one or more truthfulness predictions of logic of the to-be-processed text in the one or more prediction dimensions based on the initial text feature;
for each of the one or more prediction dimensions, obtain a correction feature of the initial text feature in the respective prediction dimension when the corresponding truthfulness prediction result in the respective prediction dimension indicates that the to-be-processed text is not truthful in the corresponding prediction dimension;
obtain a target text feature corresponding to the initial text feature based on the correction feature for each of the one or more prediction dimensions; and
obtain a target text corresponding to the to-be-processed text based on feature decoding of the target text feature.

19. The text processing apparatus according to claim 18, wherein, to obtain the respective truthfulness prediction results of the to-be-processed text, the processing circuitry is further configured to:
obtain a truthfulness prediction network corresponding to each prediction dimension; and
for each prediction dimension:
obtain a truthfulness score of the to-be-processed text in the respective prediction dimension based on the corresponding truthfulness prediction network being applied to the initial text feature;
when the truthfulness score is greater than or equal to a score threshold, determine a truthfulness prediction result as a first result indicating that the to-be-processed text is truthful in the respective prediction dimension; and
when the truthfulness score is less than the score threshold, determine the truthfulness prediction result as a second result indicating that the to-be-processed text is not truthful in the respective prediction dimension.

20. A non-transitory computer-readable storage medium storing instructions, which when executed by a processor, cause the processor to perform:
obtaining an initial text feature of a to-be-processed text based on feature encoding of the to-be-processed text;
obtaining one or more truthfulness prediction results of the to-be-processed text in one or more prediction dimensions, the one or more truthfulness prediction results corresponding to one or more truthfulness predictions of logic of the to-be-processed text in the one or more prediction dimensions based on the initial text feature;
for each of the one or more prediction dimensions, obtaining a correction feature of the initial text feature in the respective prediction dimension when the corresponding truthfulness prediction result in the respective prediction dimension indicates that the to-be-processed text is not truthful in the respective prediction dimension;
obtaining a target text feature corresponding to the initial text feature based on the correction feature for each of the one or more prediction dimensions; and
obtaining a target text corresponding to the to-be-processed text based on feature decoding of the target text feature.
